(19) United States
(12) Patent Application Publication
(10) Pub. No.: US 2020/0100192 A1
(43) Pub. Date: Mar. 26, 2020

(54) ADAPTIVE TRANSMISSION POWER CONTROL FOR WIRELESS COMMUNICATION SYSTEMS

(71) Applicant: SZ DJI TECHNOLOGY CO., LTD., Shenzhen City (CN)

(72) Inventors: Xiongbin RAO, Shenzhen (CN); Jiannan GAO, Shenzhen (CN); Naibo WANG, Shenzhen (CN); Wei FAN, Shenzhen (CN); Ming GONG, Shenzhen (CN)

(73) Assignee: SZ DJI TECHNOLOGY CO., LTD., Shenzhen City (CN)

(21) Appl. No.: 16/657,971

(22) Filed: Oct. 18, 2019

Related U.S. Application Data
(63) Continuation of application No. PCT/CN2017/081532, filed on Apr. 21, 2017.

(51) Int. Cl. H04W 52/24; H04W 52/20

(52) U.S. Cl. CPC H04W 52/247; H04W 52/245; H04W 52/20

(57) ABSTRACT

A method of controlling a transmission power of a first node configured to communicate wirelessly with one or more other nodes is described. The method may include establishing a first wireless communication link between the first node and a second node, receiving a first power adjustment value from the second node, wherein the first power adjustment value is determined based on signals transmitted by the first node over the first wireless communication link, determining a transmission power level for transmitting signals from the first node based on the received first power adjustment value, and transmitting signals from the first node over the first wireless communication link using the determined transmission power level.

### CROSS-REFERENCE TO RELATED PATENT APPLICATION

This application is a Continuation of International Application No. PCT/CN2017/081532, filed on Apr. 21, 2017, entitled “Adaptive Transmission Power Control for Wireless Communication Systems,” to X. Rao et al., published as International Publication No. WO 2018/191983, which is hereby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to wireless communication and, more particularly, to systems and methods for adaptively controlling a transmission power of a wireless communication device in a movable object, such as an unmanned aerial vehicle.

### BACKGROUND

An important consideration in wireless communication control is signal quality degradation, which can be caused by a number of factors. For example, a wireless signal transmitted at a given power level is generally received by the receiver at a lower power level as the distance between the transmitter and receiver increases. This reduction in power level is known as “path loss” and generally results in lower quality communication. Causes of path loss include free-space loss, refraction, diffraction, reflection, physical obstructions (i.e., “shadowing”), and absorption, among others. Other causes of signal degradation include signal saturation and quantization loss at the receiver. Saturation occurs when signals reach the receiver at power levels beyond the recognizable range of the receiver's analog-to-digital converter (ADC), which can occur when a signal has a wide dynamic power range. Quantization losses occur when signals reach the receiver at relatively low power levels with respect to the receiver's ADC configuration or with respect to other signals. Different interferences mechanisms, such as environmental interference or inter-signal interference caused by other signals, can increase the block error rate and reduce the signal to noise ratio experienced at the receiver, resulting in signal degradation.

Solutions for overcoming the above-mentioned factors can often have competing requirements and therefore pose a challenge to achieving high-quality communication under varying conditions. These challenges are particularly acute for “non-licensed” or “public” frequency bands for which problems of interference can be more prominent. For example, known solutions for overcoming environmental interferences, inter-signal interferences, and quantization loss include increasing the power level of the transmitter or configuring the transmitter to operate at a constant, relatively high power level. These solutions, however, can cause signal saturation, which reduces signal quality. Further, increasing the output power of a transmitter may increase the noise level at other receivers in the area (which can cause the other transmitters to respond by increasing their transmitter power levels, thereby causing all transmitters in the area to operate at relatively high power levels). This effect is known as the “near-far problem” and is sometimes used in radio-frequency jamming techniques. Transmitting at relatively high power levels also consumes more power (i.e., is less efficient), which is particularly problematic for battery-operated systems including batteries that must be periodically recharged or replaced. When such a communication system transmits at relatively high power levels, the power consumed by the system and other systems powered by a common power source may significantly reduce the time those systems may be operational.

There is a need for improved systems and methods for adaptively controlling the power level of wireless communication systems to effectively and efficiently overcome the above-mentioned problems.

### SUMMARY

In one embodiment, the present disclosure relates to a method of controlling a transmission power of a first node configured to communicate wirelessly with one or more other nodes. The method may include establishing a first wireless communication link between the first node and a second node, receiving a first power adjustment value from the second node, wherein the first power adjustment value is determined based on signals transmitted by the first node over the first wireless communication link, determining a transmission power level for transmitting signals from the first node based on the received first power adjustment value, and transmitting signals from the first node over the first wireless communication link using the determined transmission power level.

In another embodiment, the present disclosure relates to a communication system that includes a plurality of nodes. The system may include a first node configured to communicate wirelessly with other nodes. The first node may include a memory having instructions stored therein. The system may further include an electronic control unit comprising a processor configured to execute the stored instructions to establish a wireless communication link between the first node and a second node, receive a first power adjustment value from the second node, wherein the first power adjustment value is determined based on signals transmitted by the first node over the first wireless communication link, determine a transmission power level for transmitting signals to the second node based on the received first power adjustment value, and transmit signals to the second node using the determined transmission power level.

In yet another embodiment, the present disclosure relates to a non-transitory computer-readable medium storing instructions, that, when executed, cause a computer to perform a method of controlling a transmission power of a wireless communication device. The method may include establishing a first wireless communication link between the first node and a second node, receiving a first power adjustment value from the second node, wherein the first power adjustment value is determined based on signals transmitted by the first node over the first wireless communication link, determining a transmission power level for transmitting signals from the first node based on the received first power adjustment value, and transmitting signals from the first node over the first wireless communication link using the determined transmission power level.

In yet another embodiment, the present disclosure relates to a method of controlling a transmission power over a wireless communication network. The method may include determining a first block error rate and a first received signal power level at a first node based on signals transmitted by a second node over a first wireless communication link, obtaining a first power adjustment value for the second node based on the first block error rate and the first received power level, and transmitting the first power adjustment value from the first node to the second node, wherein the second node is configured to use the power adjustment value to control its transmission power over the first wireless communication link.

In yet another embodiment, the present disclosure relates to a communication system that includes a plurality of nodes. The system may include a first node configured to communicate wirelessly with other nodes. The first node may include a memory having instructions stored therein. The system may further include an electronic control unit comprising a processor configured to execute the stored instructions to determine a first block error rate and a first received signal power level at a first node based on signals transmitted by a second node over a first wireless communication link, obtain a first power adjustment value for the second node based on the first block error rate and the first received power level, and transmit the first power adjustment value from the first node to the second node, wherein the second node is configured to use the power adjustment value to control its transmission power over the first wireless communication link.

In yet another embodiment, the present disclosure relates to a non-transitory computer-readable medium storing instructions, that, when executed, cause a computer to perform a method of controlling a transmission power of a wireless communication device. The method may include determining a first block error rate and a first received signal power level at a first node based on signals transmitted by a second node over the a first wireless communication link, obtaining a first power adjustment value for the second node based on the first block error rate and the first received power level, transmitting the first power adjustment value from the first node to the second node, wherein the second node is configured to use the power adjustment value to control its transmission power over the first wireless communication link.

In yet another embodiment, the present disclosure relates to a communication system including a first node configured to communicate wirelessly with other nodes. The first node may include a memory having instructions stored therein, and an electronic control unit comprising a processor. The processor may be configured to execute the stored instructions to establish a wireless communication link between the first node and a second node, receive a first power adjustment value from the second node, wherein the first power adjustment value is determined based on signals transmitted by the first node over the first wireless communication link, determine a transmission power level for transmitting signals to the second node based on the received first power adjustment value, and transmit signals to the second node using the determined transmission power level. The first node may also be configured to determine a first block error rate and a first received signal power level at the first node based on signals transmitted by the second node over the first wireless communication link. The first node may also be configured to obtain a first power adjustment value for the second node based on the first block error rate and the first received power level. The first node may also be configured to then transmit the first power adjustment value from the first node to the second node, wherein the second node is configured to use the power adjustment value to control its transmission power over the first wireless communication link.

### BRIEF DESCRIPTION OF THE DRAWINGS

FIG. 1 is a schematic diagram of an exemplary movable object configured to communicate with an exemplary second object that may be used in accordance with the illustrative embodiments described herein;

FIG. 2 shows schematic diagrams of exemplary control systems that may be used with the movable object and second object of FIG. 1;

FIG. 3 is a schematic diagram of a wireless communication system that may be used in accordance with an illustrative embodiment;

FIG. 4 is a schematic diagram of a system for controlling a transmission power of a wireless communication device that may be used in accordance with the illustrative embodiment of FIG. 3;

FIG. 5 is a flow chart of an exemplary method of controlling a transmission power of a wireless communication device that may be used in accordance with the illustrative embodiment of FIG. 3;

FIG. 6 is a flow chart of an exemplary method of controlling a transmission power of a wireless communication device that may be used in accordance with the illustrative embodiment of FIG. 3;

FIG. 7 is a schematic diagram of two exemplary movable objects configured to communicate with an exemplary second object that may be used in accordance with the illustrative embodiments described herein;

FIG. 8 is a schematic diagram of another exemplary wireless communication system that may be used in accordance with an illustrative embodiment;

FIG. 9 is a schematic diagram of an exemplary system for controlling a transmission power of wireless communication devices that may be used in accordance with the illustrative embodiment of FIG. 7;

FIG. 10 is a flow chart of an exemplary method of controlling a transmission power of a wireless communication device that may be used in accordance with the illustrative embodiment of FIG. 9;

FIG. 11 is a flow chart of an exemplary method of controlling a transmission power of a wireless communication device that may be used in accordance with the illustrative embodiment of FIG. 9;

FIG. 12 is a flow chart of an exemplary system for controlling a transmission power of wireless communication devices that may be used in accordance with the illustrative embodiment of FIG. 9;

FIG. 13 is a block diagram of exemplary modules that may be used for a method of controlling a transmission power of a wireless communication device that may be used in accordance with the illustrative embodiment of FIG. 12;

FIG. 14 is a flow chart of an exemplary method of controlling a transmission power of a wireless communication device that may be used in accordance with the illustrative embodiment of FIG. 12;

FIG. 15 is a flow chart of an exemplary method of controlling a transmission power of a wireless communication device that may be used in accordance with the illustrative embodiment of FIG. 12;

FIG. 16 is a flow chart of an exemplary method of controlling a transmission power of a wireless communication device that may be used in accordance with illustrative embodiments of the present disclosure;

FIG. 17 is a flow chart of another exemplary method of controlling a transmission power of a wireless communication device that may be used in accordance with illustrative embodiments of the present disclosure; and

FIG. 18 is a flow chart of another exemplary method of controlling a transmission power of a wireless communication device that may be used in accordance with illustrative embodiments of the present disclosure.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

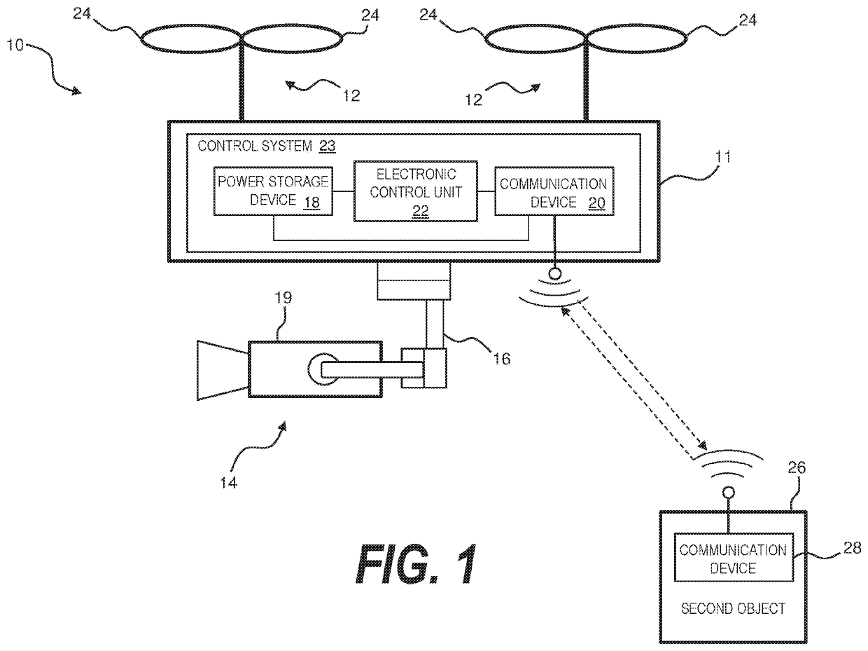

FIG. 1 shows an exemplary movable object 10 that may be configured to move within an environment. As used herein, the term “movable object” (e.g., movable object 10) may include suitable object, device, mechanism, system, or machine configured to travel on or within a suitable medium (e.g., a surface, air, water, one or more rails, space, underground, etc.). For example, movable object 10 may be an unmanned aerial vehicle (UAV). Although movable object 10 is shown and described herein as a UAV for exemplary purposes of this description, it is understood that other types of movable objects (e.g., wheeled objects, nautical objects, locomotive objects, other aerial objects, etc.) may also or alternatively be used in embodiments consistent with this disclosure. As used herein, the term “UAV” may refer to an aerial device configured to be operated and/or controlled automatically (e.g., via an electronic control system) and/or manually by off-board personnel.

Movable object 10 may include a housing 11, one or more propulsion assemblies 12, and a payload 14, such as a camera or video system. In some embodiments, as shown in FIG. 1, payload 14 may be connected or attached to movable object 10 by a carrier 16, which may allow for one or more degrees of relative movement between payload 14 and movable object 10. In other embodiments, payload 14 may be mounted directly to movable object 10 without carrier 16. Movable object 10 may also include a power storage device 18, a communication device 20, and an electronic control unit 22 in communication with the other components. In some embodiments, one or more of power storage device 18, communication device 20, and an electronic control unit 22 may be included in a control system 23. Control system 23 may be configured to control multiple systems or functions of movable object 10. Alternatively, control system 23 may be dedicated to controlling a single system or subset of functions. For example, control system 23 may be or include a flight control system of a UAV.

Movable object 10 may include one or more propulsion assemblies 12 positioned at various locations (for example, top, sides, front, rear, and/or bottom of movable object 10) for propelling and steering movable object 10. Although only two exemplary propulsion assemblies 12 are shown in FIG. 1, it will be appreciated that movable object 10 may include any number of propulsion assemblies (e.g., 1, 2, 3, 4, 5, 10, 15, 20, etc.). Propulsion assemblies 12 may be devices or systems operable to generate forces for sustaining controlled flight. Propulsion assemblies 12 may share or may each separately include at least one power source, such as one or more batteries, fuel cells, solar cells, etc., or combinations thereof. Each propulsion assembly 12 may also include one or more rotary components 24, e.g., within an electric motor, engine, or turbine, coupled to the power source and configured to participate in the generation of forces for sustaining controlled flight. For instance, rotary components 24 may include rotors, propellers, blades, etc., which may be driven on or by a shaft, axle, wheel, or other component or system configured to transfer power from the power source. Propulsion assemblies 12 and/or rotary components 24 may be adjustable (e.g., tiltable) with respect to each other and/or with respect to movable object 10. Alternatively, propulsion assemblies 12 and rotary components 24 may have a fixed orientation with respect to each other and/or movable object 10. In some embodiments, each propulsion assembly 12 may be of the same type. In other embodiments, propulsion assemblies 12 may be of multiple different types. In some embodiments, all propulsion assemblies 12 may be controlled in concert (e.g., all at the same speed and/or angle). In other embodiments, one or more propulsion devices may be independently controlled with respect to, e.g., speed and/or angle.

Propulsion assemblies 12 may be configured to propel movable object 10 in one or more vertical and horizontal directions and to allow movable object 10 to rotate about one or more axes. That is, propulsion assemblies 12 may be configured to provide lift and/or thrust for creating and maintaining translational and rotational movements of movable object 10. For instance, propulsion assemblies 12 may be configured to enable movable object 10 to achieve and maintain desired altitudes, provide thrust for movement in all directions, and provide for steering of movable object 10. In some embodiments, propulsion assemblies 12 may enable movable object 10 to perform vertical takeoffs and landings (i.e., takeoff and landing without horizontal thrust). In other embodiments, movable object 10 may require constant minimum horizontal thrust to achieve and sustain flight. Propulsion assemblies 12 may be configured to enable movement of movable object 10 along and/or about multiple axes.

Payload 14 may include one or more sensory devices 19, such as the exemplary sensory device 19 shown in FIG. 1. Sensory devices 19 may include devices for collecting or generating data or information, such as surveying, tracking, and capturing images or video of targets (e.g., objects, landscapes, subjects of photo or video shoots, etc.). Sensory devices 19 may include imaging devices configured to gathering data that may be used to generate images. For example, imaging devices may include photographic cameras (e.g., analog, digital, etc.), video cameras, infrared imaging devices, ultraviolet imaging devices, x-ray devices, ultrasonic imaging devices, radar devices, binocular cameras, etc. Sensory devices 19 may also or alternatively include devices for capturing audio data, such as microphones or ultrasound detectors. Sensory devices 19 may also or alternatively include other suitable sensors for capturing visual, audio, and/or electromagnetic signals.

Carrier 16 may include one or more devices configured to hold the payload 14 and/or allow the payload 14 to be adjusted (e.g., rotated) with respect to movable object 10. For example, carrier 16 may be a gimbal. Carrier 16 may be configured to allow payload 14 to be rotated about one or more axes, as described below. In some embodiments, carrier 16 may be configured to allow 360° of rotation about each axis to allow for greater control of the perspective of the payload 14. In other embodiments, carrier 16 may limit the range of rotation of payload 14 to less than 360° (e.g., 270°, 210°, 180, 120°, 90°, 45°, 30°, 15° etc.), about one or more of its axes.

Communication device 20 may be configured to enable communications of data, information, commands (e.g., flight commands, commands for operating payload 14, etc.), and/or other types of signals between electronic control unit 22 and off-board entities. Communication device 20 may include one or more components configured to send and/or receive signals, such as receivers, transmitters, or transceivers that are configured to carry out one- or two-way communication. Components of communication device 20 may be configured to communicate with off-board entities via one or more communication networks, such as networks configured for WLAN, radio, cellular (e.g., WCDMA, LTE, etc.), WiFi, RFID, etc., and using one or more wireless communication protocols (e.g., IEEE 802.15.1, IEEE 802.11, etc.), and/or other types of communication networks or protocols usable to transmit signals indicative of data, information, commands, control, and/or other signals. Communication device 20 may be configured to enable communications with user input devices, such as a control terminal (e.g., a remote control) or other stationary, mobile, or handheld control device, that provide user input for controlling movable object 10 during flight. For example, communication device 20 may be configured to communicate with a second object 26, which may be a user input device (e.g., a remote controller), another UAV or other movable object, a stationary or mobile object on the ground, or any other device capable of receiving and/or transmitting signals with movable object 10.

Second object 26 may be a stationary device, mobile device, or other type of device configured to communicate with movable object 10 via communication device 20. For example, in some embodiments the second object 26 may be another movable device (e.g., another UAV), a computer, a terminal, a user input device (e.g., a remote control device), etc. Second object 26 may include a communication device 28 configured to enable wireless communication with movable object 10 (e.g., with communication device 20) or other objects. Communication device 28 may be configured to receive data and information from communication device 20, such as operational data relating to, for example, positional data, velocity data, acceleration data, sensory data (e.g., imaging data), and other data and information relating to movable object 10, its components, and/or its surrounding environment. In some embodiments, second object 26 may include control features, such as levers, buttons, touch screen device, displays, etc. In some embodiments, second object 26 may embody an electronic communication device, such as a smartphone or a tablet, with virtual control features (e.g., graphical user interfaces, applications, etc.).

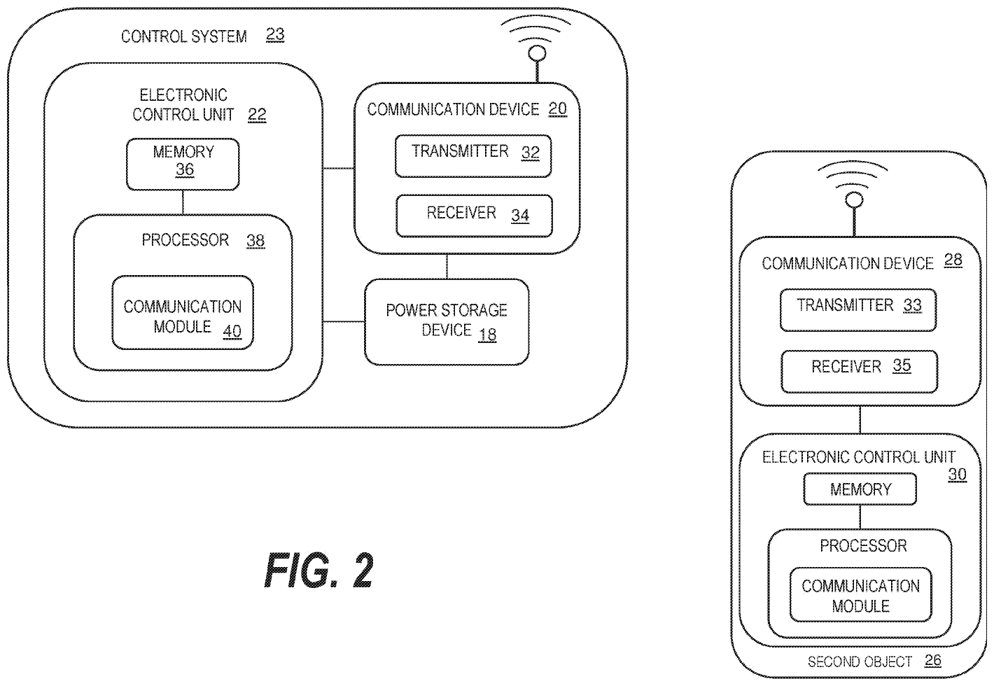

FIG. 2 is a schematic block diagram of control system 23 and second object 26, consistent with the exemplary embodiments of this disclosure. Control system 23 may include power storage device 18, communication device 20, and electronic control unit 22, among other things. Second object 26 may include, inter alia, a communication device 28 and an electronic control unit 30.

Power storage device 18 may be a device configured to energize or otherwise supply power to electronic components, mechanical components, or combinations thereof in the movable object 10. For example, power storage device 18 may be a battery, a battery bank, or other device. In other embodiments, power storage device 18 may be or include one or more of a combustible fuel, a fuel cell, or another type of power storage device.

Communication device 20 may be an electronic device configured to enable wireless communication with other devices. For example, communication device 20 may include a transmitter 32, a receiver 34, circuitry, and/or other components. Transmitter 32 and receiver 34 may be electronic components respectively configured to transmit and receive wireless communication signals. In some embodiments, transmitter 32 and receiver 34 may be separate devices or structures. In other embodiments, transmitter 32 and receiver 34 may be combined (or their respective functions may be combined) in a single transceiver device configured to send (i.e., transmit) and receive wireless communication signals, thereby functioning as a transmitter and as a receiver. Wireless communication signals may include any type of electromagnetic signal encoded with or otherwise indicative of data or information. Transmitter 32 and receiver 34 may be connected to one or more shared antennas, such as the exemplary antenna in FIG. 2, or may transmit and receive using separate antennas or antenna arrays in the movable object 10.

Communication device 20 may be configured to transmit and/or receive data from one or more other devices via suitable means of communication usable to transfer data and information to or from electronic control unit 22. For example, communication device 20 may be configured to utilize one or more local area networks (LAN), wide area networks (WAN), infrared systems, radio systems, W-Fi networks, point-to-point (P2P) networks, cellular networks, satellite networks, and the like. Optionally, relay stations, such as towers, satellites, or mobile stations, can be used, as well as any other intermediate nodes that facilitate communications between the movable object 10 and second objet 26. Wireless communications can be proximity dependent or proximity independent. In some embodiments, line-of-sight may or may not be required for communications.

Electronic control unit 22 may include one or more components, including, for example, a memory 36 and at least one processor 38. Memory 36 may be or include non-transitory computer-readable media and can include one or more memory units of non-transitory computer-readable media. Non-transitory computer-readable media of memory 36 may be or include any type of disk including floppy disks, hard disks, optical discs, DVDs, CD-ROMs, microdrive, magneto-optical disks, ROMs, RAMs, EPROMs, EEPROMs, DRAMs, VRAMs, flash memory devices, magnetic or optical cards, nanosystems (including molecular memory integrated circuits), or any type of media or device suitable for storing instructions and/or data. Memory units may include permanent and/or removable portions of non-transitory computer-readable media (e.g., removable media or external storage, such as an SD card, RAM, etc.).

Information and data from sensory devices 19 and/or other devices may be communicated to and stored in non-transitory computer-readable media of memory 36. Non-transitory computer-readable media associated with memory 36 may also be configured to store logic, code and/or program instructions executable by processor 38 to perform any of the illustrative embodiments described herein. For example, non-transitory computer-readable media associated with memory 36 may be configured to store computer-readable instructions that, when executed by processor 38, cause the processor to perform a method comprising one or more steps. The method performed by processor 38 based on the instructions stored in non-transitory computer readable media of memory 36 may involve processing inputs, such as inputs of data or information stored in the non-transitory computer-readable media of memory 36, inputs received from second object 26, inputs received from sensory devices 19, and/or other inputs received via communication device 20. The non-transitory computer-readable media may be configured to store data obtained or derived from sensory devices 19 to be processed by processor 38 and/or by second object 26 (e.g., via electronic control unit 30). In some embodiments, the non-transitory computer-readable media can be used to store the processing results produced by processor 38.

Processor 38 may include one or more processors and may embody a programmable processor (e.g., a central processing unit (CPU)). Processor 38 may be operatively coupled to memory 36 or another memory device configured to store programs or instructions executable by processor 38 for performing one or more method steps. It is noted that method steps described herein may be embodied by one or more instructions and data stored in memory 36 and that cause the method steps to be carried out when processed by the processor 38.

In some embodiments, processor 38 may include and/or alternatively may be operatively coupled to one or more control modules, such as a communication module 40 in the illustrative embodiment of FIG. 2, as described further below. Communication module 40 may be configured to help control aspects of wireless communication between movable object 10 and other objects (e.g., second object 26), such as a transmission power level of communication device 20. Communication module 40 and any other module may be implemented in software for execution on processor 38, or may be implemented in hardware and/or software components at least partially included in, or separate from, the processor 38. For example, communication module 40 may include one or more CPUs, ASICs, DSPs, FPGAs, logic circuitry, etc. configured to implement their respective functions, or may share processing resources in processor 38. As used herein, the term “configured to” should be understood to include hardware configurations, software configurations (e.g., programming), and combinations thereof, including when used in conjunction with or to describe any controller, electronic control unit, or module described herein.

The components of electronic control unit 22 can be arranged in any suitable configuration. For example, one or more of the components of the electronic control unit 22 can be located on movable object 10, carrier 16, payload 14, second object 26, sensory device 19, or an additional external device in communication with one or more of the above. In some embodiments, one or more processors or memory devices can be situated at different locations, such as on the movable object 10, carrier 16, payload 14, second object 26, sensory device 19, or on an additional external device in communication with one or more of the above, or suitable combinations thereof, such that any suitable aspect of the processing and/or memory functions performed by the system can occur at one or more of the aforementioned locations.

Second object 26 may include the same or similar components as control system 23 in structure and/or function. For example, communication device 28 of second object 26 may include a transmitter 33 and a receiver 35. Transmitter 33 and receiver 35 may be the same or similar to transmitter 32 and receiver 34, respectively, in structure and/or function and therefore will not be described in detail. Electronic control unit 30 of second object 26 may be the same or similar to electronic control unit 22 in structure (e.g., may include memory, a processor, modules, etc.) and/or function and therefore will not be described in detail.

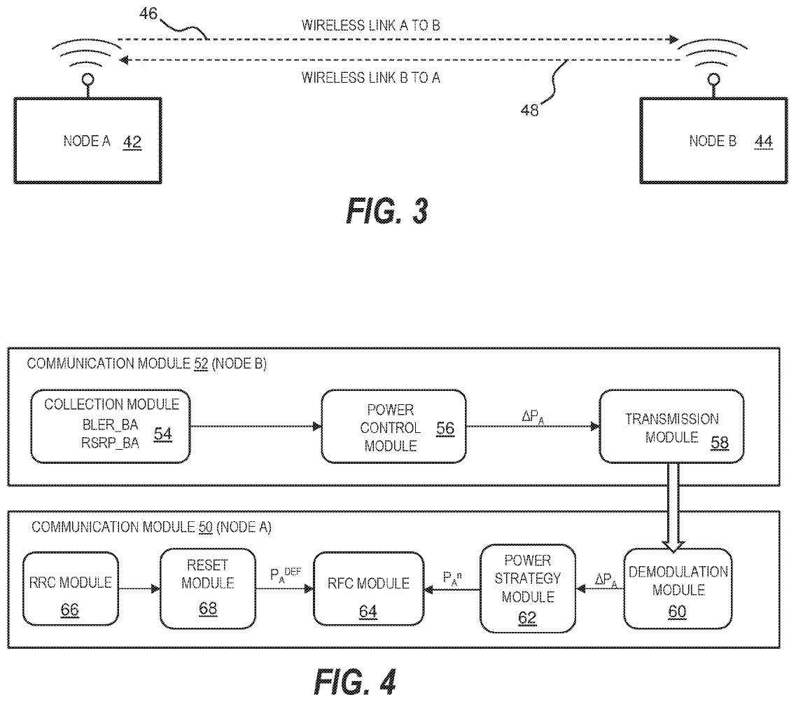

FIG. 3 shows an exemplary embodiment in which two nodes, Node A 42 and Node B 44, are configured to engage in wireless communication with each other. As used herein, the term “node” refers to any object (e.g., system, device, apparatus, etc.) equipped with hardware, software, and/or other components that enable wireless communication of electromagnetic signals with other objects. A node may include, but is not limited to, any computer system, tablet, smartphone, controller, movable object (e.g., UAV), access point, router, switch, or any other object with wireless communication capabilities. As used herein, the terms “first,” “second,” “third,” etc., when used to indicate, for example, a “first node,” “second node,” “third node,” etc., are used solely for purposes of convenience in distinguishing between or among multiple nodes in a particular example or embodiment and are not intended to be limiting in a temporal, geographical, numerical, functional, or any other sense unless otherwise stated. Similarly, alphabetical characters, such as “A,” “B,” “C,” etc., when used to indicate, for example, “Node A,” “Node B,” “Node C,” etc., are used solely for purposes of convenience in distinguishing between or among multiple nodes and are not intended to be limiting in a temporal, geographical, numerical, functional, or any other sense unless otherwise stated.

As shown in the example of FIG. 3, Node A 42 and Node B 44 may be configured to establish a wireless communication link with the other. For example, Node A 42 and Node B 44 may be configured to engage in one-to-one wireless communication (i.e., node-to-node) and/or two-way (i.e., bidirectional) wireless communication. For example, Node A 42 may transmit signals to Node B 44 via a first wireless communication link 46, and Node B may transmit signals to Node A via a second wireless communication link 48. As used herein, a wireless communication link may refer to any direct or indirect communication link between a sending device (e.g., a transmitter or transceiver) and a receiving device (e.g., a receiver or transceiver) with at least one communication performed over a wireless communication medium. In some embodiments, Node A 42 and/or Node B 44 may be a movable object, such as movable object 10, or another type of object, such as second object 26, and may therefore include an electronic control unit similar to electronic control units 22 and 30 described above.

For example, as shown in FIG. 4, Node A 42 may include a communication module 50 and Node B 44 may include a communication module 52. Communication modules 50 and 52 may be similar to communication module 40 described above and therefore may be similar in structure and function (e.g., may be implemented in hardware and/or software in conjunction with a processor). In the example of FIG. 4, the transmission power output (“transmission power”) of Node A 42 may be controlled based on information received from Node B 44. In some embodiments, the transmission power of Node B 44 may be controlled based on information received from Node A 42. Although Node A 42 and Node B 44 are shown as having different components in FIG. 4, Node A 42 also may include the components of Node B 44, and Node B 44 may include the components of Node A 42. It is to be appreciated that the following description of FIG. 4 may also apply for situations in which the roles of Node A 42 and Node B 44 are reversed.

Referring to FIG. 4, Node B 44 may be configured to collect or determine information associated with wireless communication, such as information associated with wireless communication with Node A. For example, Node B may include a collection module 54 configured to collect or determine information associated with wireless communication. Such information relating to wireless communication may include, but is not limited to, information relating to the state or quality of wireless communications between Node B 44 and another object (e.g., Node A 42), such as block error rate information, including for example block error rate (BLER) information, and received signal power level information, including for example reference signal received power (RSRP) information. Collection module 54 may be configured to collect or determine the block error rate information (BLER_{BA}) and received signal power level information (RSRP_{BA}) associated with wireless communication received by Node B 44 from Node A 42. In some embodiments, collection module 54 may be configured to receive information (e.g., BLER and RSRP) from other modules, devices, and nodes, store information (e.g., in memory), or analyze and/or process signals to determine information. For instance, collection module 54 may be configured to determine each of the BLER_{BA} and RSRP_{BA} values, or may receive at least one of the BLER_{BA} and RSRP_{BA} values as determined based on signals received from another node (e.g., Node A 42). Collection module 54 may be configured to communicate information (e.g., BLER_{BA} and RSRP_{BA}) to other modules, devices, or nodes, such as to a power control module 56 that uses such BLER and RSRP information for generating one or more power adjustment values.

Power control module 56 may be configured to obtain a power adjustment value ΔP for controlling the transmission power level of another node (e.g., Node A 42). During wireless communication between nodes (e.g., between Node A 42 and Node B 44), several operational and/or environmental factors can affect (and possibly reduce) the quality or effectiveness of wireless transmissions. The quality or effectiveness of wireless transmissions can be perceived by a receiving node (i.e., a node that receives signals from a transmitting node) in terms of a block error rate (BLER) and/or received signal power (RSRP) associated with the received signals (i.e., the signals sent by the transmitting node and received by the receiving node). For example, background noise and or other interferences can cause the block error rate of received signals to increase. When background noise is high (and cannot be controlled), signal quality can be improved by increasing the transmission power level of the transmitting node. On the other hand, transmitting signals from a transmitting node at an excessively high power level can result in an excessive received signal power lever at the receiving node, which can cause signal saturation. Transmitting signals at excessive power levels can also consume unnecessary amounts of power, which is wasteful and can be particularly problematic for nodes with limited power reserves (such as UAVs). When the received signal power level is excessive, signal quality and efficiency can be improved by reducing the transmission power level of the transmitting node. In many instances, however, the transmitting node may be unaware of the block error rate and/or received signal power perceived by a receiving node and may therefore lack sufficient information for adjusting its transmission power level for improving signal quality. To allow the signal quality between nodes (e.g. Node A 42 and Node B 44) to be improved during wireless communication, and in accordance with embodiments disclosed herein, the receiving node may be configured obtain signal quality information (such as block error rate and/or received signal power), determine a power adjustment value for the transmitting node, and transmit the determined power adjustment value to the transmitting node for use by the transmitting node in adjusting the transmitting node's transmission power level.

For example, with reference to FIG. 4, power control module 56 may be configured to determine a power adjustment value ΔP_{A} for Node A 42 based on BLER_{BA} and RSRP_{BA} values received from or determined by collection module 54. In some embodiments, power control module 56 may be configured to analyze BLER_{BA} and RSRP_{BA} and select or determine a power adjustment value ΔP_{A} that corresponds to the outcome of such analysis. For example, power control module 56 may be configured to select power adjustment value ΔP_{A} from a map or other data structure that correlates different ΔP_{A} values with various outcomes of comparing BLER_{BA} and RSRP_{BA} values to predetermined reference values. In other embodiments, power control module 56 may be configured to determine a power adjustment value ΔP_{A} based on BLER_{BA} and RSRP_{BA} values using one or more equations, algorithms, or models (e.g., using BLER_{BA} and RSRP_{BA} as variables or constants in one or more equations, algorithms, or models). It is to be appreciated that in other embodiments, other or additional information may be used to determine a power adjustment value for adjusting the transmission power level of a transmitting node based on signal characteristics determined at or by a receiving node. Additionally, other or different determination techniques (e.g., algorithms, equations, maps, models, etc.) may be used to determine, identify, or select, a power adjustment value.

Power control module 56 may be configured to communicate the power adjustment value ΔP_{A} to a transmission module 58 for transmitting the power adjustment value ΔP_{A} from Node B 44 to Node A 42. Transmission module 58 may be configured to prepare data corresponding to power adjustment value ΔP_{A} for wireless transmission to Node A 42. For example, transmission module 58 may be configured to prepare, package, encrypt, modulate, or otherwise process information corresponding to the power adjustment value ΔP_{A} for transmission via a wireless communication link to Node A 42. Upon receipt of power adjustment value ΔP_{A}, Node A 42 may be configured to use power adjustment value ΔP_{A} to control its transmission power for sending signals over a wireless communication link in order to improve the quality of signals received by Node B 44 (e.g., to reduce the block error rate or adjust the received signal power perceived at Node B 44).

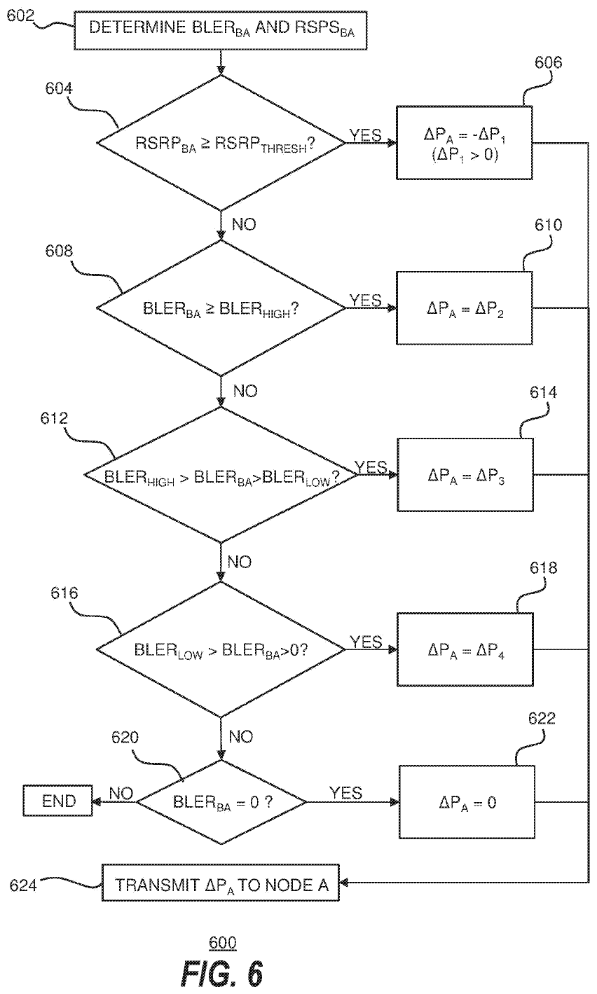

FIG. 6 shows a flow chart corresponding to an exemplary method 600 that may be performed at a second node for determining a power adjustment value (ΔP) to use at a first node. Step 602 may include determining a block error rate (e.g., BLER_{BA}) and a received signal power level (e.g., RSRP_{BA}) at the second node (e.g., Node B 44) based on signals transmitted by the first node (e.g., Node A 42) over a wireless communication link. BLER_{BA} and RSRP_{BA} may be determined, for example, by collection module 54, as described above. Step 602 shows one non-limiting example of how signal quality can be determined at a receiving node in a wireless communication system. Signal quality may also or alternatively be determined using other metrics or techniques for observing signal characteristics or signal processing performance factors that are indicative of signal quality. By understanding characteristics of signals and/or signal processing performance (e.g., performance factors of digital signal processing performed by a receiving node) in connection with signal quality may enable operational parameters at the transmitting node to be adjusted so as to improve signal quality at the receiving node.

In steps 604-622, a power adjustment value (e.g., ΔP_{A}) for the first node may be obtained (e.g., determined, received, etc.) at the second node. Steps 604-622 are one example of a multi-step iterative process for determining the power adjustment value ΔP_{A}. In many situations, analyzing BLER and RSRP (as well as other aspects and characteristics of wireless communication) can require high levels of computing power, especially in cases of wireless communication between moving nodes (e.g., nodes that move with respect to each other and/or interfering objects), as signal quality is often affected by the distance and environmental conditions between nodes engaged in wireless communication. These problems can be amplified when nodes are capable of moving rapidly and when the nodes' environment (including sources of interference, such as other nodes) dynamically and/or continuously change. Furthermore, in some situations, dynamic adjustments to the transmission power level of a transmission node (especially in the case of movable nodes) can result in overcorrection or under-correction of the transmission power level. Overcorrection and under-correction of the transmission power level can increase the computational load on the system and reduce, rather than improve, signal quality between nodes. To reduce the computational load and avoid over- or under-correction of the transmission power level when determining a power adjustment value, and consistent with embodiments disclosed herein, an iterative multi-step process for selecting a power adjustment value from a plurality of predetermined power adjustment values may be used.

For example, as shown in the embodiment of FIG. 6, BLER and RSRP may be analyzed in an iterative process to select a predetermined a power adjustment value (e.g., ΔP_{A}) from a plurality of predetermined power adjustment values of varying magnitude (e.g., ΔP₁, ΔP₂, ΔP₃, ΔP₄, etc.). Although four power adjustment values and a zero value are shown in FIG. 6, it is to be appreciated that more or fewer predetermined values may be used to achieve varying degrees power adjustment between each predetermined value. The predetermined power adjustment values may include values that correspond to an increase or a decrease of the transmission power of the receiving node. As used herein, “correspond to” in the context of an increase or a decrease of a transmission power refers to values that, if applied (e.g., added, subtracted, etc.) to the transmission power of a node, would cause an increase or decrease in the transmission power level of that node. In some situations, a value that “corresponds to” an increase or decrease in transmission power may not necessarily result in an actual increase or reduction in transmission power, such as when other factors are considered and result in a different outcome.

In the example of FIG. 6, the power adjustment value ΔP_{A} may be determined based on the block error rate BLER_{BA} and the received signal power level RSRP_{BA} as measured or calculated at the second node. In other embodiments, the BLER_{BA} and RSRP_{BA} values may be identified, derived, calculated, or otherwise obtained using information received from the first node.

In accordance with some non-limiting embodiments disclosed herein, the power adjustment value ΔP_{A} may be determined based on comparisons of the received signal power level RSRP_{BA} and/or the block error rate BLER_{BA} with respective predetermined values. For example, step 604 may include a comparison of the received signal power level RSRP_{BA} to a received signal power level threshold RSRP_{THRESH} for determining the power adjustment value ΔP_{A}. The received signal power level threshold RSRP_{THRESH} is one example of a predetermined value for determining a power adjustment value based on RSRP. The received signal power level threshold RSRP_{THRESH} may, in some embodiments, be a received signal power threshold that corresponds to a predetermined degree of signal saturation at or above which measures should be taken to reduce the received signal power at the receiving node. In other embodiments, RSRP_{THRESH} may correspond to a power level associated with a power conservation control scheme for reducing power consumption and prolonging the availability of power reserves. In other embodiments, RSRP_{THRESH} may correspond to a regulatory, operational, or other predetermined power threshold value.

At step 604, if the received signal power level RSRP_{BA} is greater than or equal to the received signal power level threshold RSRP_{THRESH} (i.e., if the outcome of step 604 is YES), the power adjustment value ΔP_{A} may be set to a negative value of −ΔP₁ at step 606. That is, when RSRP_{BA} is greater than or equal to the received signal power level threshold RSRP_{THRESH}, the received signal power level RSRP_{BA} may be deemed too high and should be reduced by the value ΔP₁. In other words, the power adjustment value ΔP_{A} may correspond to a decrease of the transmission power of the transmitting node when the received signal power exceeds a threshold. For instance, when the received signal power level RSRP_{BA} is greater than or equal to, for example, an average received signal power level of a number of communication devices in an area (which may correspond to a noise level), a predetermined power level limit, a regulatory power level limit, a power level limit for preventing signal saturation, a power level limit determined for conserving available battery power, or any other predetermined threshold value, the received signal power level RSRP_{BA} may be reduced using the predetermined value ΔP₁. In some embodiments, ΔP₁ may be selected (e.g., from a plurality of values) using a lookup table, map, or other data structure based on the magnitude of the difference between RSRP_{BA} and RSRP_{THRESH}. In other embodiments, a single value for ΔP₁ may be used during one or more iterations of method 600 until the received signal power level RSRP_{BA} is less than the received signal power level threshold RSRP_{THRESH}. In yet other embodiments, ΔP₁ may be determined based on one or more factors (e.g., the difference between RSRP_{BA} and RSRP_{THRESH}) and an equation, algorithm, or model that incorporates such factors as variables.

As also shown in the example of FIG. 6, with reference to steps 608-622, if the outcome of step 604 is NO (i.e., RSRP_{BA} is less than RSRP_{THRESH}), the power adjustment value ΔP_{A} may be a predetermined power adjustment value selected from a plurality of predetermined power adjustment values based on a comparison of the block error rate BLER_{BA} and another value. For example, BLER_{BA} may be compared to another value to determine whether or to what extent the magnitude of BLER_{BA} can or should be adjusted (e.g., decreased). As mentioned above, the transmission power of a transmitting node can be controlled in some situations to improve (e.g., reduce) the block error rate experienced at a receiving node, for example, when background noise or other interferences might be affecting the block error rate. However, as also mentioned above, drastic adjustments to the transmission power of a transmitting node can result in reduced signal quality and/or increase the computational load of the system. In one example consistent with embodiments of this disclosure, a process for determining a power adjustment value may include selecting a predetermined power adjustment value based on a BLER value, such as the magnitude of a BLER value, experienced at a receiving node. For, method 600 is one example of a process for iteratively comparing BLER values to one or more reference values and selecting a predetermined power adjustment value based on the comparison. It is to be appreciated, however, that method 600 a non-limiting exemplary process and that other methods or techniques for assessing or evaluating BLER values may be used when selecting a predetermined reference value.

In the example shown in FIG. 6 and other examples described herein, reference values (e.g., for analyzing BLER) may be associated with or partially define value ranges for use in selecting a predetermined power adjustment value. For example, as mentioned above, a the number of power adjustment values from which ΔP_{A} may be selected can vary between a single power adjustment value and any plurality of values for achieving a desired degree of adjustment between each value. Depending on how many predetermined power adjustment values are available, fewer predetermined power adjustment values may be available than possible BLER values. Thus, each predetermined power adjustment value may correspond to a range of BLER values, and this range of BLER values may decrease as more predetermined power adjustment values are available. A range of BLER values may be defined, for purposes of convenience in this explanation and not by way of limitation, by a high value (e.g., BLER_{HIGH}) and a low value (BLER_{LOW}). Additionally, a zero value (e.g., BLER=0), which may correspond to there being no block error rate (or an approximation or equivalent thereof) may, for purposes of this explanation, define a lower limit BLER value. It is to be appreciated, however, that other conventions and methods of defining selection criteria for predetermined power adjustment values may be used.

As shown in the example of FIG. 6, step 608 may include comparing the block error rate BLER_{BA} to the a block error rate reference value BLER_{HIGH} and determining whether BLER_{BA} is greater than or equal to BLER_{HIGH}. If the outcome of step 608 is YES (i.e., BLER_{BA} is greater than or equal to BLER_{HIGH}), then the power adjustment value ΔP_{A} may be set to a value ΔP₂ for adjusting the transmission power of the first node in step 610. The value ΔP₂ may correspond to a positive adjustment (i.e., an increase) to the transmission power of the first node in order to reduce the block error rate BLER_{BA}. In some situations, for example, a high block error rate can be the result of low signal strength, interference, excessive distance, and/or other factors, which can be at least partially overcome (or their effects reduced) by increasing the transmission power of the transmitting node. BLER_{HIGH} and/or any other reference BLER value may be predetermined based on empirical testing of various operating conditions (e.g., testing various atmospheric conditions, distances between nodes, levels of interference, power level restrictions, etc.) or desired signal parameters, such as a maximum allowable block error rate. In some embodiments, ΔP₂ may be selected from a lookup table, map, or other data structure based on the magnitude of the difference between BLER_{BA} and BLER_{HIGH}. In other embodiments, a single value for ΔP₂ may be used during one or more iterations of method 600 until BLER_{BA} is less than BLER_{HIGH}. In other embodiments, ΔP₂ may be determined based on one or more measured or determined factors (e.g., the factors discussed above) and an equation, algorithm, or model that incorporates such factors as variables.

If the outcome of step 608 is NO (i.e., BLER_{BA} is less than BLER_{HIGH}), then BLER_{BA} may be compared to both BLER_{HIGH} and a another block error rate reference value (e.g., BLER_{LOW}) at step 612 to determine whether BLER_{BA} is between BLER_{HIGH} and BLER_{LOW}. BLER_{LOW} may be predetermined based on empirical testing of various operating conditions (e.g., testing various atmospheric conditions, distances between nodes, levels of interference, power level restrictions, etc.) or desired signal parameters, such as a minimum block error rate below which correction thereof or adjustment of the transmission signal power of the transmitting node is less urgent or unnecessary. If the outcome of step 612 is YES (i.e., BLER_{BA} is between BLER_{HIGH} and BLER_{LOW}), then the power adjustment value ΔP_{A} may be set to a value ΔP₃ for adjusting the transmission power of the first node in step 614. The value ΔP₃ may correspond to a positive adjustment (i.e., an increase) to the transmission power of the first node in order to reduce the block error rate BLER_{BA} to a value below the current block error rate of BLER_{BA}. To avoid high volumes of complex computations for determining a precise value of ΔP₃, the value of ΔP₃ may be may be selected from a lookup table, map, or other data structure based on the magnitude of the difference between BLER_{BA} and BLER_{LOW} and/or BLER_{HIGH}. In other embodiments, a single value for ΔP₃ may be used during one or more iterations of method 600 until BLER_{BA} is less than BLER_{LOW}. In other embodiments, ΔP₃ may be determined based on one or more measured or determined factors (e.g., the factors discussed above) and an equation, algorithm, or model that incorporates such factors as variables.

If the outcome of step 612 is NO (i.e., BLER_{BA} is less than BLER_{LOW}), then BLER_{BA} may be compared to both BLER_{LOW} and a zero value (e.g., a value corresponding to there being no determined block error rate or an approximation or equivalent thereof) at step 616 to determine whether BLER_{BA} is between BLER_{LOW} and the zero value. The zero value (represented as “0” in FIG. 6) may be predetermined based on empirical testing of various operating conditions (e.g., testing various atmospheric conditions, distances between nodes, levels of interference, power level restrictions, etc.) or desired signal parameters, such as a block error rate at or below which the block error rate is zero or is reasonably estimated or assumed to be zero such that further lowering is not possible or cannot be reasonably achieved. If the outcome of step 616 is YES (i.e., BLER_{BA} is between BLER_{LOW} and the zero value), then the power adjustment value ΔP_{A} may be set to a value ΔP₄ for adjusting the transmission power of the first node in step 618. The value ΔP₄ may correspond to a positive adjustment (i.e., an increase) to the transmission power of the first node in order to reduce the block error rate BLER_{BA} to a value below the current block error rate of BLER_{BA}. To avoid high volumes of complex computations for determining a precise value of ΔP₄, the value of ΔP₄ may be may be selected from a lookup table, map, or other data structure based on the magnitude of the difference between BLER_{BA} and BLER_{LOW} and/or the zero value. In other embodiments, a single value for ΔP₄ may be used during one or more iterations of method 600 until BLER_{BA} is equal to, approximately equal to, or reasonably determined to be equivalent to the zero value (e.g., based on empirical testing). In other embodiments, ΔP₄ may be determined based on one or more measured or determined factors (e.g., the factors discussed above) and an equation, algorithm, or model that incorporates such factors as variables.

If the outcome of step 616 is NO (i.e., BLER_{BA} is not greater than the zero value), then BLER_{BA} may be compared to the zero value at step 620 to determine whether BLER_{BA} is equal to, approximately equal to, or reasonably (or otherwise) determined to be equivalent to the zero value. If the outcome of step 620 is YES (i.e., BLER_{BA} is equal to, approximately equal to, or reasonably determined to be equivalent to the zero value), then the power adjustment value ΔP_{A} may be set to a value ΔP=0 for adjusting the transmission power of the first node in step 622 (i.e., to indicate that no adjustment is necessary). If the outcome of step 620 is NO, the exemplary method in FIG. 6 may end.

Although the power adjustment values ΔP₁-ΔP₄ (i.e., ΔP₁, ΔP₂, ΔP₃, and ΔP₄) have been described as values to which ΔP_{A} may be set for purposes of adjusting the transmission power level of the first node (e.g., Node A), it is to be appreciated that more or fewer predetermined adjustment values may be used depending on the number and nature of comparisons used. Additionally, it is to be appreciated that the difference between adjacent values in the range of ΔP₁-ΔP₄ may be the same, different, equally spaced, or unequally spaced. In some embodiments, the values of ΔP₁-ΔP₄ may be related as ΔP₁>ΔP₂>ΔP₃>ΔP₄. In other embodiments, the relative sizes of ΔP₁-ΔP₄ may be arranged differently, depending on determined strategies for adjusting the transmission power level under certain operating conditions, including strategies based on how quickly and/or drastically to adjust the transmission power level of the first node with each iteration of method 600. For example, method 600 may be repeated one or more times to achieve an iterative adjustment of the transmission power level of the transmitting node (e.g., Node A 42). When the process is repeated, the Node A 42 (i.e., the transmitting node) may receive an updated power adjustment value ΔP₁ as part of an iterative process and update the transmission power level of the first node based on the updated power adjustment value. How aggressively (i.e., the degree to which) the transmission power of the transmitting node is adjusted during each iteration of the power adjustment process may be chosen by setting the magnitude and sign (e.g., positive or negative) and spacing between each predetermined power adjustment value. For example, each predetermined values can be particularly selected in order to achieve a desired power adjustment under certain conditions (e.g., depending on the magnitude or rate of change of the block error rate, received signal power, or other information). For example, large power adjustment values may correspond to larger BLER values and/or larger gaps between power adjustment values. It is to be appreciated that other adjustment relationships may be used.

If the outcome any of steps 604, 608, 612, 606, or 620 is YES, upon completion of step 606, 610, 614, 618, or 622, respectively, the power adjustment value ΔP_{A} may be transmitted to the first node at step 624. For example, the power adjustment value ΔP_{A} may be transmitted via transmission module 58 (referring to FIG. 4).

It is to be appreciated that the process described in conjunction with FIG. 6 is a non-limiting example of a technique for iteratively adjusting the transmission power level of a node. The techniques and method steps described above in conjunction with FIG. 6 have been described for purposes of explaining various aspects of the underlying techniques and are not intended to be limiting.

Referring again to FIG. 4, communication mode 50 of Node A 42 may include a demodulation module 60 configured to receive the power adjustment value ΔP_{A} from Node B 44 via the wireless communication link between them. Demodulation module 60 may be configured to receive a signal indicative of the power adjustment value ΔP_{A} (e.g., the power adjustment value determined by the second node based on block error rate and received signal power level) and demodulate, unpack, decrypt, decode, or otherwise process the received signal from which the power adjustment value ΔP_{A} may be obtained. The power adjustment value ΔP_{A} may then be communicated from demodulation module 60 to a power strategy module 62 configured to determine a transmission power level P_{A}⁽ⁿ⁾ for the first node (e.g., Node A 42) based on the power adjustment value ΔP_{A} determined by the second node (e.g., Node B 44). The transmission power level P_{A}⁽ⁿ⁾ may be determined using various methods, techniques, equations, algorithms, models, and/or other means, and is not limited to the particular examples described herein for purposes of convenience and explanation. In some embodiments, power strategy module 62 may be configured to determine the transmission power level P_{A}⁽ⁿ⁾ for the first node based on a table of values, map, or other data structure that correlates power adjustment values ΔP_{A} with transmission power level values P_{A}⁽ⁿ⁾ for the first node. In other embodiments, power strategy module 62 may be configured to determine the transmission power level P_{A}⁽ⁿ⁾ for the first node based on an equation, algorithm, or model that incorporates the power adjustment values ΔP_{A} from the second node as an input variable. The transmission power level P_{A}⁽ⁿ⁾ for the first node may be communicated to a n RFC module 64 configured to control the power level at which signals are transmitted from Node A 42. For example, RFC module 64 may control a communication device (e.g., communication device 20 or 28 or the like) to transmit signals at a power level corresponding to the transmission power level P_{A}⁽ⁿ⁾ for the first node.

Communication module 50 of Node A 42 may also include a RRC module 66 configured to determine whether a fault or error exists in the communication between the first node and the second node has faulted. For example, RRC module 66 may be configured to analyze time stamps associated with data packets received from Node B 44 to determine whether communication between Node A 42 and Node B has faulted. Alternatively, RRC module 66 may be configured to compare a local time associated with Node A 42 to a local time associated with Node B 44, a time scale associated with another node, or a global time scale, and determine whether the communication between Node A 42 and Node B 44 has faulted. Other methods of determining whether communication between Nodes A and B has faulted may be used. When RRC module 66 determines that communication between Node A 42 and Node B 44 has faulted, RRC module 66 may send a signal to a reset module 68 indicating that communication between the nodes has faulted. When reset module 68 receives a signal from RRC module 66 indicating that communication between the nodes has faulted, reset module may be configured to generate a signal indicative of a default power transmission level P_{A}^{DEF} for the first node. When communication between the nodes has faulted, the power adjustment value ΔP_{A} received from the second node may be inaccurate, indeterminate, or may not have been received due to the fault. To ensure the quality of signals generated by the first node and/or to remedy the fault communication between the first and second nodes, RFC module may control the transmission power level of the first node based on the default power transmission level P_{A}^{DEF} received from reset module 68 until the fault in communication has been restored.

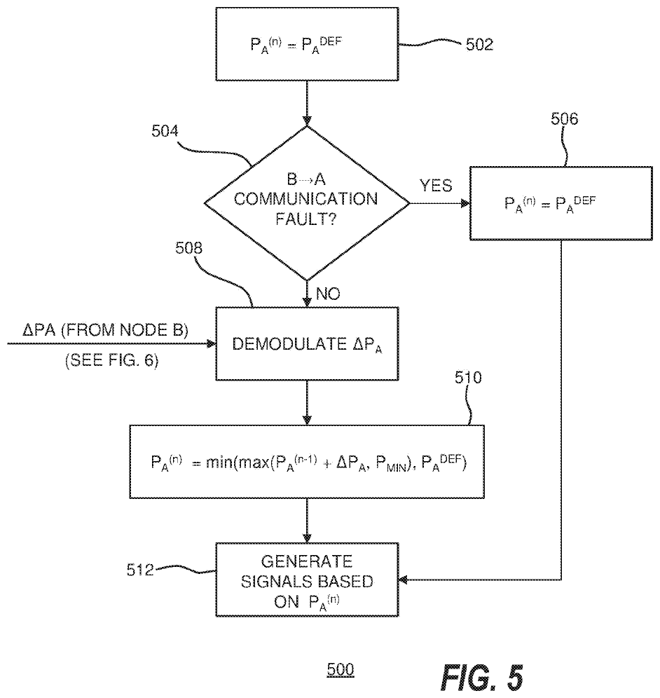

FIG. 5 shows an exemplary method 500 that may be performed at a first node (e.g., Node A) for controlling a transmission power of a wireless communication device in accordance with the illustrative embodiments discussed above. In some embodiments, method 500 may be carried out by control module 50 in conjunction with a communication device (e.g., communication device 20 or 28 or the like). In step 502, the transmission power level P_{A}⁽ⁿ⁾ for the first node may be initially set to the default power transmission level P_{A}^{DEF} of the first node. The default power transmission level P_{A}^{DEF} may correspond to a predetermined default value, such as a maximum possible power transmission level (e.g., the highest power level achievable by a communication device associated with the node), a maximum permissible power lever, a power level threshold or limit (e.g., associated with an official or regulatory requirement), a power level for achieving desired power consumption, minimizing interference with other nodes, preventing signal saturation, etc., or other type of power level value. In other embodiments, method 500 may not necessarily begin with a step of setting the transmission power level P_{A}⁽ⁿ⁾ for the first node to the default power transmission level P_{A}^{DEF}, and may instead begin with the transmission power level P_{A}⁽ⁿ⁾ at a different power level than the default power transmission level.

At step 504, a determination of whether communication between the first and second nodes (e.g., Node A 42 and Node B 44) has faulted may be performed. The determination of whether communication between the first and second nodes has faulted may be made according to the methods described above. If the outcome of step 504 is YES (i.e., when the communication between the first and second nodes has faulted), the transmission power level P_{A}⁽ⁿ⁾ for the first node may be set to the default power transmission level P_{A}^{DEF} in step 506. After completion of step 506, wireless communication signals generated by the first node may be transmitted at the transmission power level P_{A}⁽ⁿ⁾ (e.g., the default power level P_{A}^{DEF}) that was set at step 512. If the outcome of step 504 is NO (i.e., when the communication between the first and second nodes has not faulted), the method may continue to step 508 for demodulating the power adjustment value ΔP_{A} received from the second node (e.g., from Node B 44). A description of an exemplary method for determining the power adjustment value ΔP_{A} at the second node is provided above with reference to FIG. 6.

Demodulation at step 508 may be conducted according to the examples described above or according to a different method. The demodulation process at step 508 is used to extract the ΔP_{A} value from a modulated electromagnetic signal that the first node (e.g., Node A) received from the second node (e.g., Node B). After completion of step 508, the method may advance to step 510 for determining the transmission power level P_{A}⁽ⁿ⁾ for the first node. The power transmission level P_{A}⁽ⁿ⁾ for the first node may be determined using any suitable technique or mathematical process, such as by using lookup tables or maps, algorithms, equations, models, etc. One example of a mathematical process that may be used for determining the power transmission level P_{A}⁽ⁿ⁾ for the first node is shown in step 510. In the example of step 510, the transmission power level P_{A}⁽ⁿ⁾ for the first node may be determined, for example, using the following relationship:

P_{A}⁽ⁿ⁾=min(max(P_{A}⁽ⁿ⁻¹⁾+ΔP_{A},P_{MIN}),P_{A}^{DEF})

where P_{A}⁽ⁿ⁾ is the currently-determined transmission power level for the first node, P_{A}⁽ⁿ⁻¹⁾ is the previously-determined transmission power level of the first node (e.g., the value determined during a previous iteration of method 500 or the value to which P_{A}⁽ⁿ⁾ was otherwise previously set), ΔP_{A} is the power adjustment valued determined at the second node, P_{MIN} is a minimum power level (e.g., a minimum possible power level, a predetermined minimum permissible power level, or an otherwise determined minimum power level), and P_{A}^{DEF} is the default power transmission level (as described above). In some embodiments, P_{MIN} may be the minimum possible power level at which an associated communication device is capable of transmitting signals. In other embodiments, P_{MIN} may be the minimum possible power level at which signals of a desired quality (e.g., based on threshold BLER or RSRP values) are or can be achieved, or an empirically determined minimum power level that is sufficient to achieve desired results under various environmental or operational conditions. It is to be appreciated that P_{MIN} may be any threshold value for use in the exemplary relationship shown above as a value corresponding to or defining a value range or boundary thereof. A predetermined minimum possible power level may include an empirically or theoretically (e.g., based on a model or algorithm) determined power level that achieves a desired level signal quality, or a predetermined value based on regulatory requirements or limitations (e.g., divisions in spectrum, permissible spectrum use, etc.). After completion of step 510, wireless communication signals may be generated at step 512 by the first node and transmitted using the power level P_{A}⁽ⁿ⁾ determined at step 510.

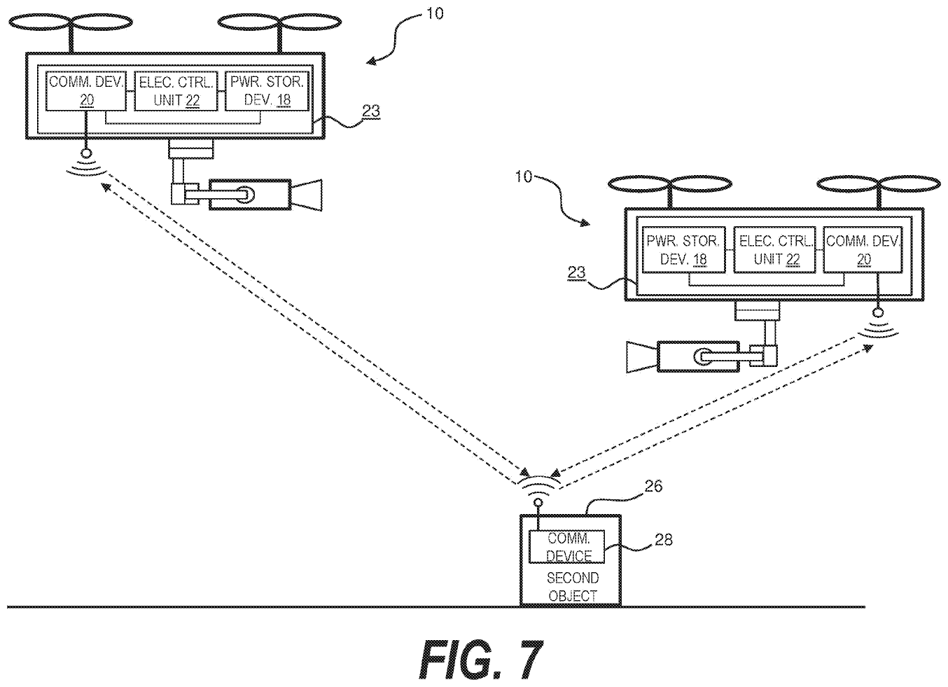

In a wireless communication environment, two nodes may engage in one-to-one communication in the absence or presence of other nodes. In other instances, a wireless communication environment may include more than two nodes, and one or more of such nodes may be configured to engage in “one-to-many” (e.g., node-to-nodes) or “many-to-one” (e.g., nodes-to-node) communication with other nodes in the wireless communication environment. For example, FIG. 7 shows an embodiment in which multiple (e.g., two) exemplary movable objects 10 (e.g., as nodes) may be configured to move within an environment. The multiple movable objects 10 may be configured to communicate wirelessly with second object 26 (e.g., another node). Each of the movable objects 10 may be in two-way wireless communication with second object 26, and thus the example of FIG. 7 may describe exemplary “many-to-one” and “one-to-many” communication scenarios. In other words, the multiple movable objects 10 may communicate with the same second object 26, and second object 26 may communicate with each of the multiple movable objects 10.

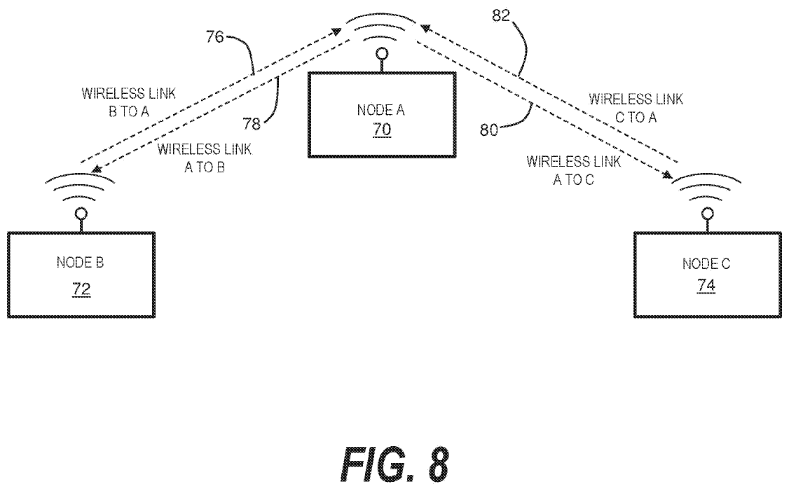

As shown in FIG. 8, Node A 70 (e.g., a first node) may be configured to establish a wireless communication link with Node B 72 (e.g., a second node) and Node C 74 (e.g., a third node). Node A 70 may be configured to engage in one-to-one (i.e., node-to-node) and/or two-way (i.e., bidirectional) wireless communication with each of Node B 72 and Node C 74. For example, Node A 70 may transmit signals to Node B 72 via a first wireless communication link 76 and Node B 72 may transmit signals to Node A 70 via a second wireless communication link 78. Similarly, Node A 70 may transmit signals to Node C 74 via a first wireless communication link 80 and Node C 74 may transmit signals to Node A 70 via a second wireless communication link 82. In some embodiments, Node A 70 and/or Node B 72 and Node C 74 may each be a movable object, such as movable object 10, or another type of object, such as second object 26, and may therefore include an electronic control unit similar to electronic control units 22 and/or 30 described above.

When a node engages in wireless communication with multiple other nodes, or when multiple nodes engage in wireless communication with a common node, situations may arise when communication between two nodes can affect communication between two different nodes. For example, situations may arise in which multiple receiving nodes in respective communication with a common node receive signals of different quality levels from the same node. This difference may be the result of several factors, including the distance of each receiving node to the transmitting node and the environmental conditions (including background noise levels caused by other nodes and/or other devices). Thus, when single transmitting node transmits signals at one power level to multiple receiving nodes, each receiving node may desire for the transmitting node to adjust its transmission power level differently than the other receiving node in order to receive signals of better quality (e.g., of reduced BLER, without saturation, etc.). The following descriptive exemplary embodiments address solutions for improving communication among nodes engaged in many-to-one or one-to-many communication.

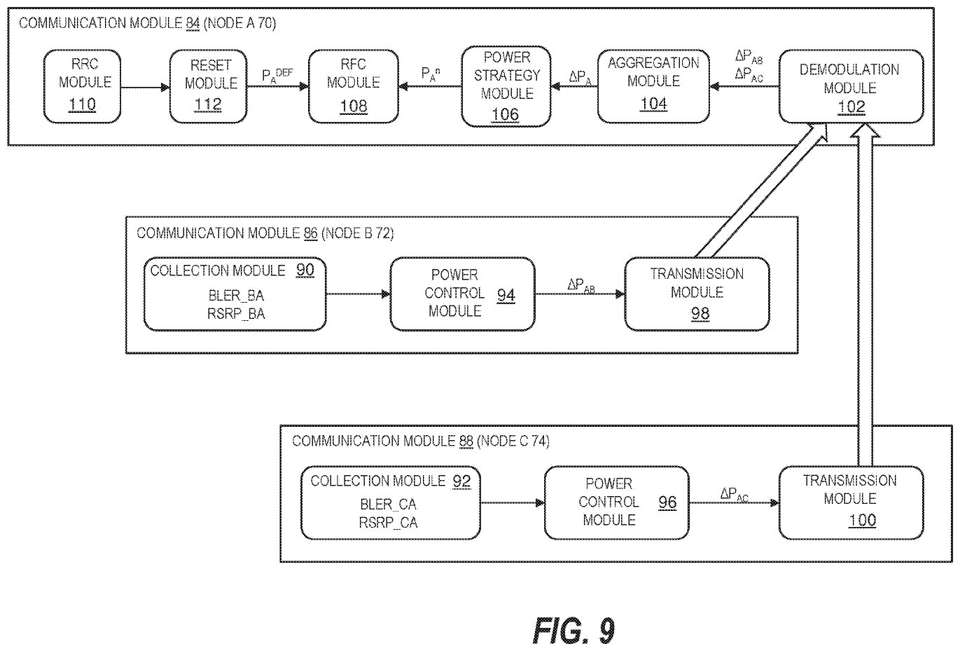

As shown in FIG. 9, Node A 70 may include a communication module 84, Node B 72 may include a communication module 86, and Node C 74 may include a communication module 88. Communication modules 84-88 may be similar to communication module 40 described above and may therefore be similar in structure and function (e.g., may be implemented in hardware and/or software in conjunction with a processor). In the example of FIG. 9, the transmission power output (“transmission power”) of Node A 70 may be controlled based on information received from Node B 72 and Node C 74. In other embodiments, the transmission power of Nodes B 72 and C 74 may be controlled based on information received from Node A 70 (as will be discussed below). Thus, although Node A 70 and Nodes B 72 and C 74 are shown as having different components in FIG. 9, it is to be appreciated that Node A 70 may also include the components of Node B 72 or C 74, and Nodes B 72 and C 74 may also include the components of Node A 70.

Referring to FIG. 9, Node B 72 and Node C 74 may include collection modules 90 and 92, respectively. Collection modules 90 and 92 may be configured to collect information associated with wireless communication. Information relating to wireless communication may include, but is not limited to, information relating to the state or quality of wireless communication between a respective node (e.g., Node B 72 or Node C 74) and another object (e.g., Node A 70) from the perspective of the respective node. Such information may include block error rate (BLER) information and received signal power level (RSRP) information. Collection module 90 may be configured to collect the block error rate information (BLER_{BA}) and received signal power level information (RSRP_{BA}) associated with wireless communication received by Node B 72 from Node A 70. Collection module 92 may be configured to collect the block error rate information (BLER_{CA}) and received signal power level information (RSRP_{CA}) associated with wireless communication received by Node C 74 from Node A 70. In some embodiments, collection modules 90 and 92 may be configured to receive information (e.g., BLER and RSRP information) from other modules or devices, store information (e.g., in memory), or analyze and/or process signals to determine information. For instance, collection modules 90 and 92 may be configured to determine respective BLER and RSRP values or receive respective BLER and RSRP values that were determined by another module. Collection modules 90 and 92 may be configured to communicate information (e.g., BLER and RSRP information) to other devices, such as a power control module 94 and 96, respectively, for generating power adjustment values.

Power control modules 94 and 96 may each be configured to obtain a power adjustment value ΔP for controlling the transmission power level of another node (e.g., Node A 70). For example, power control module 94 may be configured to determine a power adjustment value ΔP_{AB} for Node A 70 based on BLER_{BA} and RSRP_{BA} values received from collection module 90. Power control module 96 may be configured to determine a power adjustment value ΔP_{AC} for Node A 70 based on BLER_{CA} and RSRP_{CA} values received from collection module 92. In some embodiments, power control modules 94 and 96 may be configured to analyze BLER and RSRP values and select or determine power adjustment value values ΔP_{AB} and ΔP_{AC}, respectively, that correspond to the outcome of such analysis. For example, power control modules 94 and 96 may be configured to select power adjustment value ΔP_{AB} and ΔP_{AC} from a map that relates ΔP_{AB} or ΔP_{AC} to various outcomes of comparing BLER and RSRP values to predetermined reference values. In other embodiments, power control modules 94 and 96 may be configured to determine power adjustment values ΔP_{AB} and ΔP_{AC} based on respective BLER and RSRP values using one or more equations, algorithms, or models (e.g., using BLER and RSRP values as variables or constants in one or more equations, algorithms, or models).

Power control modules 94 and 96 may be configured to communicate the power adjustment values ΔP_{AB} and ΔP_{AC} to transmission modules 98 and 100, respectively, for transmitting the power adjustment values ΔP_{AB} and ΔP_{AC} from Node B 72 and Node C 74 to Node A 70. In this way, Node A 70 may receive first and second power adjustment values (e.g., ΔP_{AB} and ΔP_{AC}) from Node B 72 and Node C74, wherein each of the first and second power adjustment values are determined based on signals transmitted by the first node over first and second wireless communication links, respectively, in a wireless communication network. Transmission modules 98 and 100 may be configured to prepare data corresponding to power adjustment value ΔP_{AB} or ΔP_{AC}, respectively, for wireless transmission to Node A 70. For example, transmission modules 98 and 100 may be configured to prepare, package, encrypt, modulate, or otherwise process information corresponding to power adjustment value ΔP_{AB} or ΔP_{AC}, respectively, for transmission via a wireless communication link to Node A 70. Upon receipt of power adjustment values ΔP_{AB} and ΔP_{AC}, Node A 70 may be configured to use power adjustment values ΔP_{AB} and ΔP_{AC} to control its transmission power for sending signals over a wireless communication link.

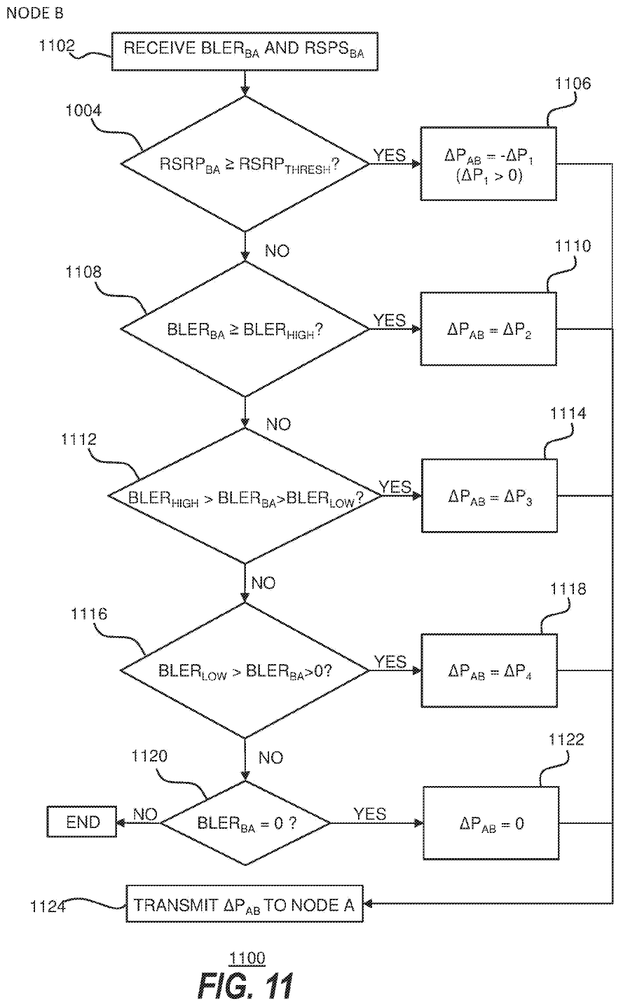

FIG. 11 shows an exemplary method 1100 for determining a power adjustment value for a first node at a second node that may be conducted by or in conjunction with Node B 72. Step 1102 may include determining a block error rate (e.g., BLER_{BA}) and a received signal power level (e.g., RSRP_{BA}) at the second node (e.g., Node B 72) based on signals transmitted by the first node (e.g., Node A 70) over a wireless communication link. BLER_{BA} and RSRP_{BA} may be determined, for example, by collection module 90, as described above.

In steps 1104-1122, a power adjustment value (e.g., ΔP_{AB}) for the first node may be obtained (e.g., determined, received, etc.) at the second node. The power adjustment value ΔP_{AB} may be determined based on the block error rate BLER_{BA} and the received signal power level RSRP_{BA}. In some embodiments, the power adjustment value ΔP_{AB} may be determined based on comparisons of the received signal power level RSRP_{BA} or the block error rate BLER_{BA} to respective predetermined values. For example, step 1104 may include a comparison of the received signal power level RSRP_{BA} to a received signal power level threshold RSRP_{THRESH} for determining the power adjustment value ΔP_{AB}. At step 1104, if the received signal power level RSRP_{BA} is greater than or equal to the received signal power level threshold RSRP_{THRESH} (i.e., if the outcome of step 1104 is YES), the power adjustment value ΔP_{AB} may be set to a negative value of −ΔP₁ at step 1106. That is, when RSRP_{BA} is greater than or equal to the received signal power level threshold RSRP_{THRESH}, the received signal power level RSRP_{BA} may be deemed to be too high and should be reduced by the value ΔP₁. For instance, when the received signal power level RSRP_{BA} is greater than, for example, the average received signal power level of a number of communication devices in an area, a predetermined power level limit, a regulatory power level limit, a power level limit for preventing signal saturation, a power level limit determined for conserving available battery power, or another predetermined value, the received signal power level RSRP_{BA} may be reduced using the predetermined value ΔP₁. In some embodiments, ΔP₁ may be selected from a lookup table, map, or other data structure based on the magnitude of the difference between RSRP_{BA} and RSRP_{THRESH}. In other embodiments, a single value for ΔP₁ may be used during one or more iterations of method 1100 until the received signal power level RSRP_{BA} is less than the received signal power level threshold RSRP_{THRESH}. In other embodiments, ΔP₁ may be determined based on one or more factors (e.g., the difference between RSRP_{BA} and RSRP_{THRESH}) and an equation, algorithm, or model that incorporates such factors as variables.

As also shown in the example of FIG. 11, with reference to steps 1108-1122, if the outcome of step 1104 is NO (i.e., RSRP_{BA} is less than RSRP_{THRESH}), the power adjustment value ΔP_{AB} may be a predetermined power adjustment value selected from a plurality of predetermined power adjustment values based on a comparison of the block error rate BLER_{BA} and at least one of a first reference block error rate value (e.g., BLER_{HIGH}), a second reference block error rate value (e.g., BLER_{LOW}), and a zero value (or other reference value). Step 1108 may include comparing the block error rate BLER_{BA} to the first reference block error rate threshold BLER_{HIGH} and determining whether BLER_{BA} is greater than or equal to BLER_{HIGH}. If the outcome of step 1108 is YES (i.e., BLER_{BA} is greater than or equal to BLER_{HIGH}), then the power adjustment value ΔP_{AB} may be set to a value ΔP₂ for adjusting the transmission power of the first node in step 1110. The value ΔP₂ may correspond to a positive adjustment (i.e., an increase) to the transmission power of the first node in order to reduce the block error rate BLER_{BA} to a value below BLER_{HIGH}. In some situations, a high block error rate can be the result of low signal strength, interference, excessive distance, and/or other factors, which can be at least partially overcome (or their effects reduced) by increasing the transmission power of the transmitting node. BLER_{HIGH} may be predetermined based on empirical testing of various operating conditions (e.g., testing various atmospheric conditions, distances between nodes, levels of interference, power level restrictions, etc.) or desired signal parameters, such as a maximum allowable block error rate. In some embodiments, ΔP₂ may be selected from a lookup table, map, or other data structure based on the magnitude of the difference between BLER_{BA} and BLER_{HIGH}. In other embodiments, a single value for ΔP₂ may be used during one or more iterations of method 1100 until BLER_{BA} is less than BLER_{HIGH}. In other embodiments, ΔP₂ may be determined based on one or more measured or determined factors (e.g., the factors discussed above) and an equation, algorithm, or model that incorporates such factors as variables.

If the outcome of step 1108 is NO (i.e., BLER_{BA} is less than BLER_{HIGH}), then BLER_{BA} may be compared to both BLER_{HIGH} and a minimum block error rate threshold (e.g., BLER_{LOW}) at step 1112 to determine whether BLER_{BA} is between BLER_{HIGH} and BLER_{LOW}. BLER_{LOW} may be predetermined based on empirical testing of various operating conditions (e.g., testing various atmospheric conditions, distances between nodes, levels of interference, power level restrictions, etc.) or desired signal parameters, such as a minimum block error rate below which correction thereof or adjustment of the transmission signal power of the transmitting node is less urgent or unnecessary. If the outcome of step 1112 is YES (i.e., BLER_{BA} is between BLER_{HIGH} and BLER_{LOW}), then the power adjustment value ΔP_{AB} may be set to a value ΔP₃ for adjusting the transmission power of the first node in step 1114. The value ΔP₃ may correspond to a positive adjustment (i.e., an increase) to the transmission power of the first node in order to reduce the block error rate BLER_{BA} to a value below the current block error rate of BLER_{BA}. To avoid high volumes of complex computations for determining a precise value of ΔP₃, the value of ΔP₃ may be may be selected from a lookup table, map, or other data structure based on the magnitude of the difference between BLER_{BA} and BLER_{LOW} and/or BLER_{HIGH}. In other embodiments, a single value for ΔP₃ may be used during one or more iterations of method 1100 until BLER_{BA} is less than BLER_{LOW}. In other embodiments, ΔP₃ may be determined based on one or more measured or determined factors (e.g., the factors discussed above) and an equation, algorithm, or model that incorporates such factors as variables.

If the outcome of step 1112 is NO (i.e., BLER_{BA} is less than BLER_{LOW}), then BLER_{BA} may be compared to both BLER_{LOW} and a zero value (e.g., a value corresponding to there being no determined block error rate) at step 1116 to determine whether BLER_{BA} is between BLER_{LOW} and the zero value. The zero value (represented as “0” in FIG. 11) may be predetermined based on empirical testing of various operating conditions (e.g., testing various atmospheric conditions, distances between nodes, levels of interference, power level restrictions, etc.) or desired signal parameters, such as a block error rate at or below which the block error rate is zero or is reasonably estimated or assumed to be zero such that further lowering is not possible or cannot be reasonably achieved. If the outcome of step 1116 is YES (i.e., BLER_{BA} is between BLER_{LOW} and the zero value), then the power adjustment value ΔP_{AB} may be set to a value ΔP₄ for adjusting the transmission power of the first node in step 1118. The value ΔP₄ may correspond to a positive adjustment (i.e., an increase) to the transmission power of the first node in order to reduce the block error rate BLER_{BA} to a value below the current block error rate of BLER_{BA}. To avoid high volumes of complex computations for determining a precise value of ΔP₄, the value of ΔP₄ may be may be selected from a lookup table, map, or other data structure based on the magnitude of the difference between BLER_{BA} and BLER_{LOW} and/or the zero value. In other embodiments, a single value for ΔP₄ may be used during one or more iterations of method 1100 until BLER_{BA} is equal to, approximately equal to, or reasonably determined to be equivalent to the zero value (e.g., based on empirical testing). In other embodiments, ΔP₄ may be determined based on one or more measured or determined factors (e.g., the factors discussed above) and an equation, algorithm, or model that incorporates such factors as variables.

If the outcome of step 1116 is NO (i.e., BLER_{BA} is not greater than the zero value), then BLER_{BA} may be compared to the zero value at step 1120 to determine whether BLER_{BA} is equal to, approximately equal to, or reasonably determined to be equivalent to the zero value. If the outcome of step 1120 is YES (i.e., BLER_{BA} is equal to, approximately equal to, or reasonably determined to be equivalent to the zero value), then the power adjustment value ΔP_{AB} may be set to a value ΔP=0 for adjusting the transmission power of the first node in step 1122 (i.e., to indicate that no adjustment is necessary). If the outcome of step 1120 is NO, the exemplary method in FIG. 11 may end.

Although the power adjustment values ΔP₁-ΔP₄ have been described as values to which ΔP_{AB} may be set for purposes of adjusting the transmission power level of the first node, it is to be appreciated that more or fewer predetermined adjustment values may be used depending on the number and nature of comparisons used. Additionally, it is to be appreciated that the difference between adjacent values in the range of ΔP₁-ΔP₄ may be the same, different, equally spaced, or unequally spaced. In some embodiments, the values of ΔP₁-ΔP₄ may be related as ΔP₁>ΔP₂>ΔP₃>ΔP₄. In other embodiments, the relative sizes of ΔP₁-ΔP₄ may be arranged differently, depending on determined strategies for adjusting the transmission power level under certain operating conditions, including strategies based on how quickly and/or drastically to adjust the transmission power level of the first node with each iteration of method 1100.

If the outcome any of steps 1104, 1108, 1112, 1116, or 1120 is YES, upon completion of step 1106, 1110, 1114, 1118, or 1122, respectively, the power adjustment value ΔP_{AB} may be transmitted to the first node at step 1124. For example, the power adjustment value ΔP_{AB} may be transmitted via transmission module 98 (referring to FIG. 9).

It is to be appreciated that the method described above with reference to FIG. 11 may be similar to the method described above with reference to FIG. 6, and that certain descriptions of the method described with reference to FIG. 6 that pertain to similar features in the method described with reference to FIG. 11 may equally apply to both methods and vice versa. As with the method described above with reference to FIG. 6, the method described with reference to FIG. 11 is an example of one method or process for implementing aspects of the disclosure and is not intended to be limiting.

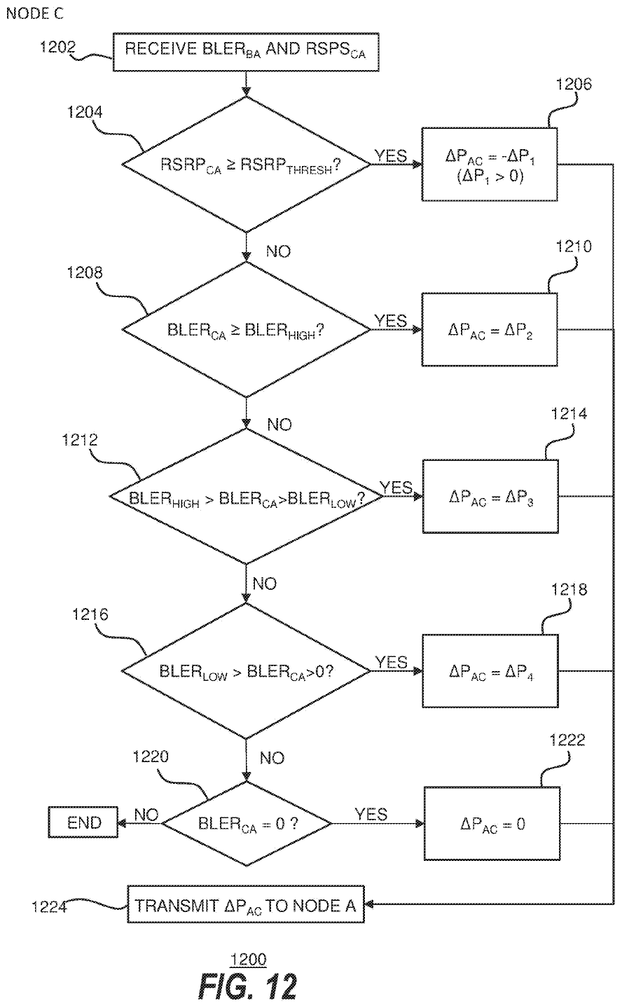

FIG. 12 shows an exemplary method 1200 for determining a power adjustment value for a first node at a third node that may be conducted by or in conjunction with Node C 74. Step 1202 may include determining a block error rate (e.g., BLER_{CA}) and a received signal power level (e.g., RSRP_{CA}) at the third node (e.g., Node C 74) based on signals transmitted by the first node (e.g., Node A 70) over a wireless communication link. BLER_{CA} and RSRP_{CA} may be determined, for example, by collection module 92, as described above.

In steps 1204-1222, a power adjustment value (e.g., ΔP_{AC}) for the first node may be obtained (e.g., determined, received, etc.) at the third node. The power adjustment value ΔP_{AC} may be determined based on the block error rate BLER_{CA} and the received signal power level RSRP_{CA}. In some embodiments, the power adjustment value ΔP_{AC} may be determined based on comparisons of the received signal power level RSRP_{CA} or the block error rate BLER_{CA} to respective predetermined values. For example, step 1204 may include a comparison of the received signal power level RSRP_{CA} to a received signal power level threshold RSRP_{THRESH} for determining the power adjustment value ΔP_{AC}. At step 1204, if the received signal power level RSRP_{CA} is greater than or equal to the received signal power level threshold RSRP_{THRESH} (i.e., if the outcome of step 1204 is YES), the power adjustment value ΔP_{AC} may be set to a negative value of −ΔP₁ at step 1206. That is, when RSRP_{CA} is greater than or equal to the received signal power level threshold RSRP_{THRESH}, the received signal power level RSRP_{CA} may be deemed to be too high and should be reduced by the value ΔP₁. For instance, when the received signal power level RSRP_{CA} is greater than, for example, the average received signal power level of a number of communication devices in an area, a predetermined power level limit, a regulatory power level limit, a power level limit for preventing signal saturation, a power level limit determined for conserving available battery power, or another predetermined value, the received signal power level RSRP_{CA} may be reduced using the predetermined value ΔP₁. In some embodiments, ΔP₁ may be selected from a lookup table, map, or other data structure based on the magnitude of the difference between RSRP_{CA} and RSRP_{THRESH}. In other embodiments, a single value for ΔP₁ may be used during one or more iterations of method 1200 until the received signal power level RSRP_{CA} is less than the received signal power level threshold RSRP_{THRESH}. In other embodiments, ΔP₁ may be determined based on one or more factors (e.g., the difference between RSRP_{CA} and RSRP_{THRESH}) and an equation, algorithm, or model that incorporates such factors as variables.

As also shown in the example of FIG. 12, with reference to steps 1208-1222, if the outcome of step 1204 is NO (i.e., RSRP_{CA} is less than RSRP_{THRESH}), the power adjustment value ΔP_{AC} may be a predetermined power adjustment value selected from a plurality of predetermined power adjustment values based on a comparison of the block error rate BLER_{CA} and at least one of a first reference block error rate value (e.g., BLER_{HIGH}), a second reference block error rate value (e.g., BLER_{LOW}), and a zero value (or other reference value). Step 1208 may include comparing the block error rate BLER_{CA} to the first reference block error rate value BLER_{HIGH} and determining whether BLER_{CA} is greater than or equal to BLER_{HIGH}. If the outcome of step 1208 is YES (i.e., BLER_{CA} is greater than or equal to BLER_{HIGH}), then the power adjustment value ΔP_{AC} may be set to a value ΔP₂ for adjusting the transmission power of the first node in step 1210. The value ΔP₂ may correspond to a positive adjustment (i.e., an increase) to the transmission power of the first node in order to reduce the block error rate BLER_{CA} to a value below BLER_{HIGH}. In some situations, a high block error rate can be the result of low signal strength, interference, excessive distance, and/or other factors, which can be at least partially overcome (or their effects reduced) by increasing the transmission power of the transmitting node. BLER_{HIGH} may be predetermined based on empirical testing of various operating conditions (e.g., testing various atmospheric conditions, distances between nodes, levels of interference, power level restrictions, etc.) or desired signal parameters, such as a maximum allowable block error rate. In some embodiments, ΔP₂ may be selected from a lookup table, map, or other data structure based on the magnitude of the difference between BLER_{CA} and BLER_{HIGH}. In other embodiments, a single value for ΔP₂ may be used during one or more iterations of method 1200 until BLER_{CA} is less than BLER_{HIGH}. In other embodiments, ΔP₂ may be determined based on one or more measured or determined factors (e.g., the factors discussed above) and an equation, algorithm, or model that incorporates such factors as variables.

If the outcome of step 1208 is NO (i.e., BLER_{CA} is less than BLER_{HIGH}), then BLER_{CA} may be compared to both BLER_{HIGH} and a minimum block error rate threshold (e.g., BLER_{LOW}) at step 1212 to determine whether BLER_{CA} is between BLER_{HIGH} and BLER_{LOW}. BLER_{LOW} may be predetermined based on empirical testing of various operating conditions (e.g., testing various atmospheric conditions, distances between nodes, levels of interference, power level restrictions, etc.) or desired signal parameters, such as a minimum block error rate below which correction thereof or adjustment of the transmission signal power of the transmitting node is less urgent or unnecessary. If the outcome of step 1212 is YES (i.e., BLER_{CA} is between BLER_{HIGH} and BLER_{LOW}), then the power adjustment value ΔP_{AC} may be set to a value ΔP₃ for adjusting the transmission power of the first node in step 1214. The value ΔP₃ may correspond to a positive adjustment (i.e., an increase) to the transmission power of the first node in order to reduce the block error rate BLER_{CA} to a value below the current block error rate of BLER_{CA}. To avoid high volumes of complex computations for determining a precise value of ΔP₃, the value of ΔP₃ may be may be selected from a lookup table, map, or other data structure based on the magnitude of the difference between BLER_{CA} and BLER_{LOW} and/or BLER_{HIGH}. In other embodiments, a single value for ΔP₃ may be used during one or more iterations of method 1200 until BLER_{CA} is less than BLER_{LOW}. In other embodiments, ΔP₃ may be determined based on one or more measured or determined factors (e.g., the factors discussed above) and an equation, algorithm, or model that incorporates such factors as variables.

If the outcome of step 1212 is NO (i.e., BLER_{CA} is less than BLER_{LOW}), then BLER_{CA} may be compared to both BLER_{LOW} and a zero value (e.g., a value corresponding to there being no determined block error rate) at step 1216 to determine whether BLER_{CA} is between BLER_{LOW} and the zero value. The zero value (represented as “0” in FIG. 11) may be predetermined based on empirical testing of various operating conditions (e.g., testing various atmospheric conditions, distances between nodes, levels of interference, power level restrictions, etc.) or desired signal parameters, such as a block error rate at or below which the block error rate is zero or is reasonably estimated or assumed to be zero such that further lowering is not possible or cannot be reasonably achieved. If the outcome of step 1216 is YES (i.e., BLER_{CA} is between BLER_{LOW} and the zero value), then the power adjustment value ΔP_{AC} may be set to a value ΔP₄ for adjusting the transmission power of the first node in step 1218. The value ΔP₄ may correspond to a positive adjustment (i.e., an increase) to the transmission power of the first node in order to reduce the block error rate BLER_{CA} to a value below the current block error rate of BLER_{CA}. To avoid high volumes of complex computations for determining a precise value of ΔP₄, the value of ΔP₄ may be may be selected from a lookup table, map, or other data structure based on the magnitude of the difference between BLER_{CA} and BLER_{LOW} and/or the zero value. In other embodiments, a single value for ΔP₄ may be used during one or more iterations of method 1200 until BLER_{CA} is equal to, approximately equal to, or reasonably determined to be equivalent to the zero value (e.g., based on empirical testing). In other embodiments, ΔP₄ may be determined based on one or more measured or determined factors (e.g., the factors discussed above) and an equation, algorithm, or model that incorporates such factors as variables.

If the outcome of step 1216 is NO (i.e., BLER_{CA} is not greater than the zero value), then BLER_{CA} may be compared to the zero value at step 1220 to determine whether BLER_{CA} is equal to, approximately equal to, or reasonably determined to be equivalent to the zero value. If the outcome of step 1220 is YES (i.e., BLER_{CA} is equal to, approximately equal to, or reasonably determined to be equivalent to the zero value), then the power adjustment value ΔP_{AC} may be set to a value ΔP=0 for adjusting the transmission power of the first node in step 1222 (i.e., to indicate that no adjustment is necessary). If the outcome of step 1220 is NO, the exemplary method in FIG. 12 may end.

Although the power adjustment values ΔP₁-ΔP₄ have been described as values to which ΔP_{AC} may be set for purposes of adjusting the transmission power level of the first node, it is to be appreciated that more or fewer predetermined adjustment values may be used depending on the number and nature of comparisons used. Additionally, it is to be appreciated that the difference between adjacent values in the range of ΔP₁-ΔP₄ may be the same, different, equally spaced, or unequally spaced. In some embodiments, the values of ΔP₁-ΔP₄ may be related as ΔP₁>ΔP₂>ΔP₃>ΔP₄. In other embodiments, the relative sizes of ΔP₁-ΔP₄ may be arranged differently, depending on determined strategies for adjusting the transmission power level under certain operating conditions, including strategies based on how quickly and/or drastically to adjust the transmission power level of the first node with each iteration of method 1200.

If the outcome any of steps 1204, 1208, 1212, 1216, or 1220 is YES, upon completion of step 1206, 1210, 1214, 1218, or 1222, respectively, the power adjustment value ΔP_{AC} may be transmitted to the first node at step 1224. For example, the power adjustment value ΔP_{AC} may be transmitted via transmission module 100 (referring to FIG. 9).

It is to be appreciated that the method described above with reference to FIG. 12 may be similar to the methods described above with reference to FIGS. 6, and 11, and that certain descriptions of the methods described with reference to FIGS. 6 and 11 that pertain to similar features in the method described with reference to FIG. 11 may equally apply the other methods and vice versa. As with the methods described above with reference to FIGS. 6 and 11, the method described with reference to FIG. 11 is an example of one method or process for implementing aspects of the disclosure and is not intended to be limiting.

Referring again to FIG. 9, communication mode 84 of Node A 70 may include a demodulation module 102 configured to receive the power adjustment values ΔP_{AB} and ΔP_{AC} from Node B 72 and Node C 74 via the wireless communication links between them. Demodulation module 102 may be configured to receive a signal including information indicative of the power adjustment values ΔP_{AB} and ΔP_{AC} (e.g., the power adjustment value determined by the second and third nodes based on block error rate and received signal power level information) and demodulate, unpack, decrypt, decode, or otherwise process the received signal from which the power adjustment values ΔP_{AB} and ΔP_{AC} may be obtained.

In many instances, Node B 72 and Node C 74 may not be similarly situated with respect to Node A 70 and other aspects of the environment, and thus Node B 72 and Node C 74. For example, Node B 74 and Node C 74 may each be different distances from Node A 70 and/or may experience different levels of interference caused by other nodes or other environmental factors. Thus, the power adjustment values ΔP_{AB} and ΔP_{AC} of Node B 72 and Node C 74 may not be equal. That is, in some instances, one of ΔP_{AB} and ΔP_{AC} may have a greater (or lesser) magnitude than the other and/or may be of a different sign (e.g., positive or negative). In other words, depending on the circumstances, ΔP_{AB} and ΔP_{AC} may respectively correspond to power adjustments of Node A 70 in the same or different directions (e.g., increase or decrease), and a difference (e.g., a mathematical difference) may exists between the values of ΔP_{AB} and ΔP_{AC}.

The power adjustment values ΔP_{AB} and ΔP_{AC} may be communicated from demodulation module 102 to an aggregation module 104 configured to determine a single power adjustment value ΔP_{A} for Node A 70 based on ΔP_{AB} and ΔP_{AC}. Aggregation module 104 may be configured to analyze multiple power adjustment values from a plurality of nodes (e.g., ΔP_{AB} and ΔP_{AC}) and determine a single power adjustment value ΔP_{A} for controlling the transmission power of Node A based on the analysis. For example, as in the situations mentioned above in which ΔP_{AB} and ΔP_{AC} may be different (i.e., a difference exists between them), the determined power adjustment value ΔP_{A} may be determined based on the difference between ΔP_{AB} and ΔP_{AC}. In such situations, Node B 72 and Node C 74 may have competing interests with respect to how the transmission power level of Node A 70 may be adjusted. Node A 70 (i.e., the transmitting node) may be configured to determine a power adjustment value based on a first power adjustment value (e.g., ΔP_{AB}) received from Node B 72 and a second power adjustment value (ΔP_{AC}) received from Node C 74. That is, from ΔP_{AB} and ΔP_{AC} Node A 70 may be configured to determine a single power adjustment value for controlling its power transmission level. Node A 70 may be configured to then determine a transmission power level (e.g., for itself) based on the single determined power adjustment value (i.e., based on ΔP_{AB} and ΔP_{AC}). Node A 70 may be configured to determine its power adjustment value based on ΔP_{AB} and ΔP_{AC} using suitable mathematical, analytical, or other techniques and is not limited to the exemplary methods described herein.

For example, in some embodiments, aggregation module 104 may be configured to determine the smallest power adjustment value among the received power adjustment values or the largest power adjustment value among the received power adjustment values and set ΔP_{A} to the largest or smallest power adjustment value, depending on other factors. For example, in some situations, the power adjustment value from a first node (e.g., ΔP_{AB}) may be a positive value while the power adjustment value from another node (e.g., ΔP_{AC}) may be negative. If the smallest of the smallest received power adjustment value is a negative value (e.g., for decreasing the power output of the first node), then, for example, the received signal power the node generating the negative power adjustment value may have exceeded a threshold and the received signal may be saturated. That is, the power of the signal received at that node may be too high and should be reduced, even though another node (e.g., that generated a positive power adjustment value) may desire the transmission power of the transmitting node to be increased. In some embodiments, under such circumstances, the smallest of the received power adjustment values may be selected (i.e., corresponding to a decrease in the transmission power of the transmitting node). In other situations, such as when the received power adjustment values from both receiving nodes (e.g., Node B 72 and Node C 74) are positive values (e.g., for increasing the transmission power output of the first node), then the largest received power adjustment value may be selected in order to increase the signal quality at the node requesting the larger power adjustment without significantly disadvantaging the node that requested the smaller increase (of course, while considering any upper limit thresholds for the received signal power at either node, and decreasing the transmission power level if such a threshold is exceeded, as described above). In other embodiments, aggregation module may utilize the received power adjustment values in one or more algorithms, equations, or models to determine a power adjustment value to which ΔP_{A} is set. Such algorithms, equations, or models may include averaging, weighted averaging, or system specific operations based on hardware, software, or environmental requirements.

A power strategy module 106 may be configured to determine a transmission power level P_{A}⁽ⁿ⁾ for the first node (e.g., Node A 70) based on the power adjustment value ΔP_{A} that was determined based on the power adjustment values (e.g., ΔP_{AB} and ΔP_{AC}) received from the second and third nodes (e.g., Node B 72 and Node C 74). In some embodiments, power strategy module 106 may be configured to determine the transmission power level P_{A}⁽ⁿ⁾ for the first node based on a table of values, map, or other data structure that correlates power adjustment value ΔP_{A} with transmission power level values P_{A}⁽ⁿ⁾ for the first node. In other embodiments, power strategy module 106 may be configured to determine the transmission power level P_{A}⁽ⁿ⁾ for the first node based on an equation, algorithm, or model that incorporates the power adjustment value ΔP_{A} as an input variable. The transmission power level P_{A}⁽ⁿ⁾ for the first node may be communicated to an RFC module 108 configured to control the power level at which signals are transmitted from Node A 70. For example, RFC module 64 may control a communication device (e.g., communication device 20 or 28 or the like) to transmit signals at a power level corresponding to the transmission power level P_{A}⁽ⁿ⁾ for the first node.

Communication module 84 of Node A 70 may also include a RRC module 110 configured to determine whether communication between the first node and the second or third node has faulted. For example, RRC module 110 may be configured to analyze time stamps associated with data packets received from Node B 72 and Node C 74 to determine whether communication between Node A 70 and Node B 72 or C 74 has faulted. Alternatively, RRC module 110 may be configured to compare a local time associated with Node A 70 to a local time associated with Node B 72 or Node C 74, a time scale associated with another node, or a global time scale, and determine whether the communication between Node A 70 and Node B 72 or Node C 74 has faulted. Other methods of determining whether communication between Node A and Nodes B and C has faulted may be used. When RRC module 110 determines that communication between Node A 70 and Node B 72 or Node C 74 has faulted, RRC module 110 may send a signal to a reset module 112 indicating that communication between the nodes has faulted. When reset module 112 receives a signal from RRC module 110 indicating that communication between the nodes has faulted, reset module may be configured to generate a signal indicative of a default power transmission level P_{A}^{DEF} for the first node. When communication between the nodes has faulted, the power adjustment value ΔP_{AB} or ΔP_{AC} received from the second and third nodes may be inaccurate, indeterminate, or may not have been received due to the fault. To ensure the quality of signals generated by the first node and/or to remedy the fault in communication between the first and second or third node, RFC module 108 may control the transmission power level of the first node based on the default power transmission level P_{A}^{DEF} received from reset module 112 until no fault is detected.

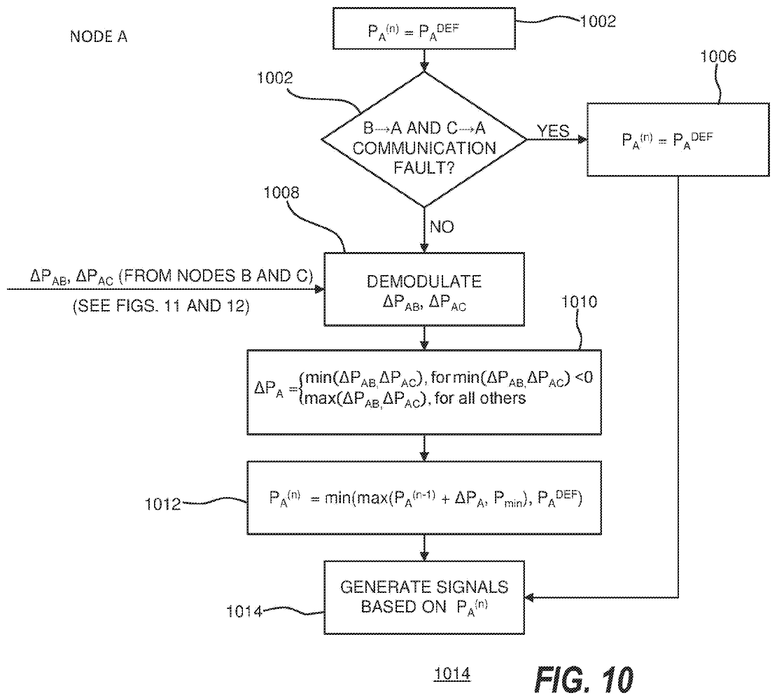

FIG. 10 shows an exemplary method 1000, consistent with the descriptions above, that may be performed by a first node (e.g., Node A) for controlling a transmission power of a wireless communication device in accordance with the illustrative embodiments discussed above. In some embodiments, method 1000 may be carried out by control module 84 in conjunction with a communication device (e.g., communication device 20 or 28 or the like). In step 1002, the transmission power level P_{A}⁽ⁿ⁾ for the first node may be initially set to the default power transmission level P_{A}^{DEF} of the first node. The default power transmission level P_{A}^{DEF} may correspond to a maximum possible power transmission level (e.g., the highest power level achievable by a communication device associated with the node), a maximum permissible power lever, a power level threshold or limit (e.g., associated with an official or regulatory requirement), or other type of power level value. In other embodiments, method 1000 may not necessarily begin with a step of setting the transmission power level P_{A}⁽ⁿ⁾ for the first node to the default power transmission level P_{A}^{DEF}, and may instead begin with the transmission power level P_{A}⁽ⁿ⁾ at a different power level than the default power transmission level.

At step 1004, a determination of whether communication between the first and second or third nodes has faulted may be made. The determination of whether communication between the first and second nodes has faulted may be made according to the methods described above. If the outcome of step 1004 is YES (i.e., when the communication between the first and second nodes has faulted), the transmission power level P_{A}⁽ⁿ⁾ for the first node may be set to the default power transmission level P_{A}^{DEF} in step 1006. After completion of step 1006, wireless communication signals generated by the first node may be transmitted at the transmission power level P_{A}⁽ⁿ⁾ that was set (e.g., the default power level P_{A}^{DEF}) at step 1014. If the outcome of step 1004 is NO (i.e., when the communication between the first node and second and third nodes has not faulted), the method may continue to step 1008 for demodulating the power adjustment values ΔP_{AB} and ΔP_{AC} received from the second and third nodes (e.g., from Node B 72 and Node C 74). Descriptions of exemplary methods for determining the power adjustment values ΔP_{AB} and ΔP_{AC} at the second and third nodes are provided above with reference to FIGS. 11 and 12.

Demodulation at step 1008 may be conducted according to the examples described above or according to a different method. The demodulation process at step 1008 is used to extract the ΔP_{AB} and ΔP_{AC} values from modulated electromagnetic signals that the first node (e.g., Node A) received from the second and third nodes (e.g., Nodes B and C). After completion of step 1008, the method may advance to step 1010 for determining ΔP_{A} based on ΔP_{AB} and ΔP_{AC}. In some embodiments, ΔP_{A} may be determined by demodulation module 102 or in the manner thereof, described above. For example, in some embodiments the following relationships may be used to determine ΔP_{A}:

$$Δ {P}_{A} = \{ \begin{matrix}min ( Δ {P}_{AB} , Δ {P}_{AC} ) , for min ( Δ {P}_{AB} , Δ {P}_{AC} ) < 0 \\ max ( Δ {P}_{AB} , Δ {P}_{AC} ) , for all others\end{matrix}$$

The relationship above may be one example of an implementation of the principles described above with regard to determining a single power adjustment value for a transmitting node based on multiple power adjustment values received by a plurality of receiving nodes. The above relationship is not intended to be limiting on this disclosure or the claims by virtue of its inclusion in this description. Other mathematical or analytical techniques or methods may be used to determine a power adjustment value for a transmitting node based on a plurality of received power adjustment values from a plurality of receiving nodes. The transmission power level P_{A}⁽ⁿ⁾ for the first node may be determined at step 1012. The transmission power level P_{A}⁽ⁿ⁾ for the first node may then be determined, for example, using the following relationship:

P_{A}⁽ⁿ⁾=min(max(P_{A}⁽ⁿ⁻¹⁾+ΔP_{A},P_{MIN}),P_{A}^{DEF})

where P_{A}⁽ⁿ⁾ is the currently-determined transmission power level for the first node, P_{A}⁽ⁿ⁻¹⁾ is the previously-determined transmission power level of the first node (e.g., the value determined during a previous iteration of method 1000 or the value to which P_{A}⁽ⁿ⁾ was otherwise previously set), ΔP_{A} is the power adjustment valued determined based on the power adjustment values determined at the second and third nodes, P_{MIN} is a minimum power level (e.g., a minimum possible power level, a predetermined minimum permissible power level, or an otherwise determined minimum power level, as described above), and P_{A}^{DEF} is the default power transmission level (as described above). In some embodiments, P_{MIN} may be the minimum possible power level at which an associated communication device is capable of transmitting signals. In other embodiments, P_{MIN} may be the minimum possible power level at which signals of a desired quality (e.g., based on threshold BLER or RSRP values) are or can be achieved, or an empirically determined minimum power level that is sufficient to achieve desired results under various environmental or operational conditions. A predetermined minimum possible power level may include an empirically or theoretically (e.g., based on a model or algorithm) determined power level that achieves a desired level signal quality, or a predetermined value based on regulatory requirements or limitations (e.g., divisions in spectrum, permissible spectrum use, etc.). After completion of step 1012, wireless communication signals may be generated by the first node at step 1014 and transmitted using the power level P_{A}⁽ⁿ⁾ determined at step 1012.

As mentioned above, when a node engages in wireless communication with multiple other nodes, or when multiple nodes engage in wireless communication with a common node, situations may arise when communication between two nodes can affect communication between two different nodes. For example, situations may arise in which a common receiving node in respective communication with a plurality of transmitting nodes receives signals of different quality levels from the respective transmitting nodes. This difference may be the result of several factors, including the distance of the receiving node from each of the transmitting nodes and the environmental conditions (including background noise levels caused by other nodes and/or other devices). Thus, when multiple transmitting nodes transmit signals at to a single receiving node, the single receiving node may desire for each transmitting node to adjust its respective transmission power level differently than the other in order to receive signals of better quality (e.g., of reduced BLER, without saturation, etc.) from each node. The following descriptive exemplary embodiments address solutions for improving communication among nodes engaged in many-to-one communication.

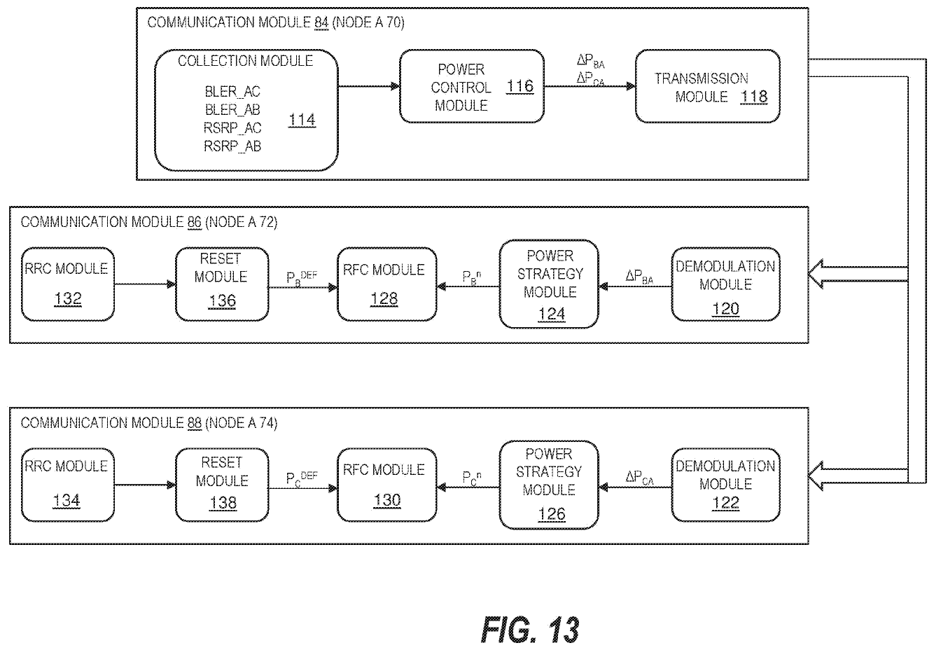

FIG. 13, shows an example of one-to-many communication between Node A 70 and Nodes B 72 and C 74 (i.e., communication in the reverse direction with respect to FIG. 9). Communication modules 84-88 in FIG. 13 may correspond to communication modules 84-88 described above and may therefore include any or all features described above with respect to FIG. 9. In the example of FIG. 13, the transmission power output (or “transmission power”) of Nodes B 72 and C 74 may be controlled based on information received from Node A 70. Node A 70 may include a collection module 114 configured to collect information associated with wireless communication. Information relating to wireless communication may include, but is not limited to, information relating to the state or quality of wireless communication between a first node (e.g., Node A 70) and another object (e.g., Node B 72 or Node C 74) from the perspective of the first node. Such information may include block error rate (BLER) information and received signal power level (RSRP) information. Collection module 114 may be configured to collect the block error rate information (BLER_{AB} and BLER_{AC}) and received signal power level information (RSRP_{AB} and RSRP_{AC}) associated with wireless communication received by Node A 70 from Node B 72 and Node C 74. In some embodiments, collection module 114 may be configured to receive information (e.g., BLER and RSRP information) from other modules or devices, store information (e.g., in memory), or analyze and/or process signals to determine information. For instance, collection module 114 may be configured to determine BLER and RSRP values or receive BLER and RSRP values that were determined by another module. Collection module 114 may be configured to communicate information (e.g., BLER and RSRP information) to other devices, such as a power control module 116 for generating power adjustment values.

Power control module 116 may be configured to obtain a power adjustment value ΔP_{BA} and ΔP_{CA} for controlling the transmission power level of Nodes B 72 and C 74, respectively. That is, in some instances Node A 70 may wish for both Node B 72 and Node C to increase their transmission power levels, for both Node B 72 and Node C to decrease their transmission power levels, for one node to increase and the other to decrease its transmission power level, or for one node to not adjust its transmission power level while the other increases or decreases its transmission power level. Such scenarios may arise depending on such factors as the distance between each of Node B 72 and Node C 74 with respect to Node A, the level of background noise, and/or other environmental considerations. For example, power control module 116 may be configured to determine a power adjustment value ΔP_{BA} for Node B 72 and ΔP_{CA} for Node C 74 based on BLER_{AB}, RSRP_{AB}, BLER_{AC} and RSRP_{AC} values received from collection module 114. In some embodiments, power control module 116 may be configured to analyze the BLER and RSRP values and select or determine power adjustment value values ΔP_{BA} and ΔP_{CA} that correspond to the outcome of such analysis. For example, power control module 116 may be configured to select power adjustment values ΔP_{BA} and ΔP_{CA} from a map that relates ΔP_{BA} or ΔP_{CA} to various outcomes of comparing the BLER and RSRP values to predetermined reference values. In other embodiments, power control module 116 may be configured to determine power adjustment values ΔP_{BA} and ΔP_{CA} based on BLER and RSRP values using one or more equations, algorithms, or models (e.g., using BLER and RSRP values as variables or constants in one or more equations, algorithms, or models).

It is to be appreciated that that in many-to-one wireless communication, multiple transmitting nodes communicating with a common receiving node may, in some instances, generate noise to each other, thereby affecting how the receiving node may determine how to command each transmitting node to adjust its respective transmission power level. For example, Node A 70 may be configured to obtain or determine power adjustment values ΔP_{BA} and ΔP_{CA} to reduce a difference between the received signal powers RSRP_{AB} and RSRP_{AC}. Alternatively, Node A 70 may be configured to determine a signal to noise ratio for each transmitting node (e.g., Node B 72 and Node C 74) and determine power adjustment values ΔP_{BA} and ΔP_{CA} to reduce a difference between the signal to noise ratios associated with each transmitting node. Minimizing such differences may result in achieving a state of communication in which signals from Node B 74 and Node C 74 are received at node A 70 with similar quality levels, such that only relatively small power adjustment values (ΔP_{BA} and ΔP_{CA}) are generated by Node A 70 during each iteration of the process. In this way, high quality communication between Node A 70 and each of the other nodes (e.g., Node B 72 and Node C 74) may be quickly achieved and easily maintained.

At times, due to the independent nature of Node B 72 and Node C 74 and the complexity of the surrounding environment, Node A 70 may be configured to obtain different power adjustment values (e.g., in both magnitude and mathematical sign) for Node B 72 and Node C 74 based on its perception of signal quality from both nodes (e.g., as indicated by BLER_{AB}, RSRP_{AB}, BLER_{AC} and RSRP_{AC}) while also taking into account such environmental conditions as background noise.

For instance, in some situations, such as when Node A 70 is configured to reduce a difference between Node B 74 and Node C 74 (e.g., a difference in received signal power, a difference in block error rate, a difference in signal to noise ratio, etc.) Node A 70 may be configured to obtain power adjustment values ΔP_{BA} and ΔP_{CA} that respectively correspond to an increase in the transmission power of at least one of Node B 72 and Node C. In other situations, Node A 70 may obtain power adjustment values ΔP_{BA} and ΔP_{CA} that respectively correspond to a decrease in the transmission power of at least one of Node B 72 and Node C. In other situations, Node A 70 may obtain power adjustment values ΔP_{BA} and ΔP_{CA} that respectively correspond to an increase in the transmission power of one Node B 72 and Node C 74 and a decrease in the transmission power of the other of Node B 72 and Node C 74.

In other situations, such as when Node A 70 is configured to adjust the transmission power levels of Node B 74 and Node C 74 based on environmental conditions, such as a background noise level, Node A 70 may be configured to obtain power adjustment values ΔP_{BA} and ΔP_{CA} that respectively correspond to an increase in the transmission power of at least one (e.g., one or both) of Node B 72 and Node C, such as when the background noise increases and higher transmission power is desired to improve signal quality. In other situations, Node A 70 may obtain power adjustment values ΔP_{BA} and ΔP_{CA} that respectively correspond to a decrease in the transmission power of at least one (e.g., one or both) of Node B 72 and Node C, such as when the background noise is reduced and a desired signal quality can be achieved using lower transmission power levels. In other situations, Node A 70 may obtain power adjustment values ΔP_{BA} and ΔP_{CA} that respectively correspond to an increase in the transmission power of one Node B 72 and Node C 74 and a decrease in the transmission power of the other of Node B 72 and Node C 74. Such a situation may arise, for example, in embodiments in which Node A 70 is configured to obtain power adjustment values ΔP_{BA} and ΔP_{CA} based on a background noise level and to reduce a difference between Node B 72 and Node C 74, as described above.

Referring again to FIG. 13, power control module 116 may be configured to communicate the power adjustment values ΔP_{BA} and ΔP_{CA} to transmission module 118 for transmitting the power adjustment values ΔP_{BA} and ΔP_{CA} from Node A 70 to Nodes B 72 and C 74. Transmission module 118 may be configured to prepare data corresponding to power adjustment values ΔP_{BA} and ΔP_{CA} for wireless transmission to Nodes B 72 and C 74. For example, transmission modules 118 may be configured to prepare, package, encrypt, modulate, or otherwise process information corresponding to power adjustment values ΔP_{BA} or ΔP_{CA} for transmission via a wireless communication link to Nodes B 72 and C 74. Upon receipt of power adjustment values ΔP_{BA} and ΔP_{CA}, respectively, Nodes B 72 and C 74 may be configured to use the power adjustment values ΔP_{BA} and ΔP_{CA} to control their respective transmission powers for sending signals over a wireless communication link.

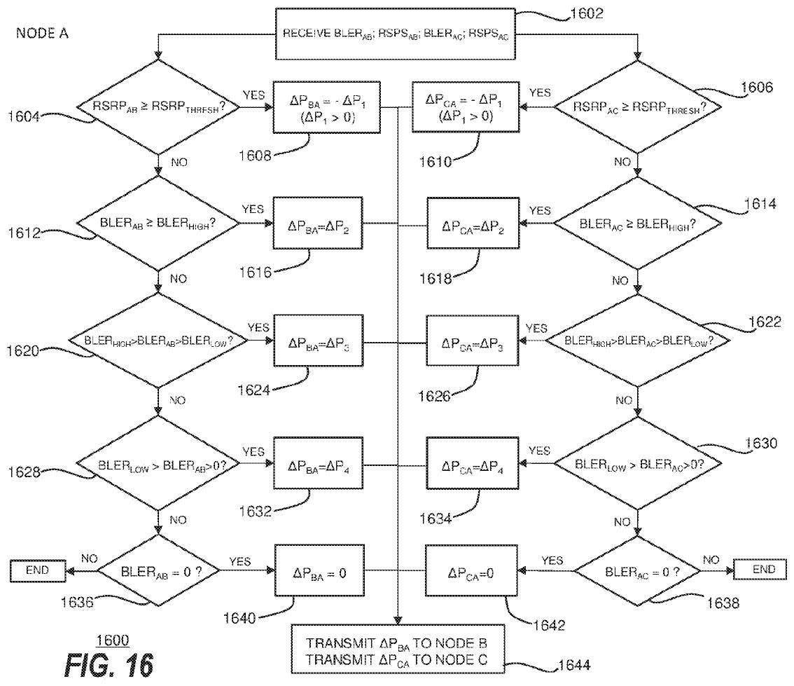

FIG. 16 shows an exemplary method 1600 for determining power adjustment values at a first node for a second node and a third node that may be conducted by or in conjunction with the embodiment of FIG. 13. Step 1602 may include determining block error rates (e.g., BLER_{AB} and BLER_{AC}) and received signal power levels (e.g., RSPS_{AB} and RSRP_{AC}) at the first node (e.g., Node A 70) based on signals transmitted by the second and third nodes (e.g., Nodes B 72 and C 74) over a wireless communication link. The BLER and RSRP data may be determined, for example, by collection module 114, as described above.

In steps 1604-1644, power adjustment values (e.g., ΔP_{BA} and ΔP_{CA}) for the second and third nodes may be obtained (e.g., determined, received, etc.) at the first node. It is to be appreciated that the numbering of steps 1604-1644 is provided purely for convenience, and that the number of such steps alone do not limit the order in which such steps may be completed; various orders of steps 1604-1644 may be used. The power adjustment values ΔP_{BA} and ΔP_{CA} may be determined based on the block error rate BLER_{AB} and BLER_{AC} and the received signal power levels RSRP_{AB} and RSRP_{AC}. In some embodiments, the power adjustment values ΔP_{BA} and ΔP_{CA} may be determined based on comparisons of the received signal power level RSRP values or the block error rate BLER values to respective predetermined values. For example, steps 1604 and 1606 may respectively include comparisons of the received signal power level RSRP_{AB} and RSRP_{AC} to a received signal power level threshold RSRP_{THRESH} for determining the power adjustment values ΔP_{BA} and ΔP_{CA}, respectively. At steps 1604 and 1606, if the received signal power level RSRP_{AB} or RSRP_{AC} is greater than or equal to the received signal power level threshold RSRP_{THRESH} (i.e., if the outcome of step 1604 or 1606 is YES), the power adjustment value ΔP_{BA} or ΔP_{CA} may be set to a negative value of −ΔP₁ at steps 1608 and 1610, respectively. That is, when RSRP_{AB} or RSRP_{AC} is greater than or equal to the received signal power level threshold RSRP_{THRESH}, the received signal power level RSRP_{AB} or RSRP_{AC} may be deemed to be too high and should be reduced by the value ΔP₁. For instance, when the received signal power level RSRP_{AB} or RSRP_{AC} is greater than, for example, the average received signal power level of a number of communication devices in an area, a predetermined power level limit, a regulatory power level limit, a power level limit for preventing signal saturation, a power level limit determined for conserving available battery power, or another predetermined value, the received signal power level RSRP_{AB} or RSRP_{AC} may be reduced using the predetermined value ΔP₁. In some embodiments, ΔP₁ may be selected from a lookup table, map, or other data structure based on the magnitude of the difference between RSRP_{AB} or RSRP_{AC} and RSRP_{THRESH}. In other embodiments, a single value for ΔP₁ may be used during one or more iterations of method 1600 until the received signal power level RSRP_{AB} or RSRP_{AC} is less than the received signal power level threshold RSRP_{THRESH}. In other embodiments, ΔP₁ may be determined based on one or more factors (e.g., the difference between RSRP_{AB} or RSRP_{AC} and RSRP_{THRESH}) and an equation, algorithm, or model that incorporates such factors as variables.

As also shown in the example of FIG. 16, if the outcome of step 1604 or 1606 is NO (i.e., RSRP_{AB} or RSRP_{AC} is less than RSRP_{THRESH}), the power adjustment value ΔP_{BA} or ΔP_{CA} may be a predetermined power adjustment value selected from a plurality of predetermined power adjustment values based on a comparison of the block error rate BLER_{AB} or BLER_{AC} and at least one of a first reference block error rate value (e.g., BLER_{HIGH}), a second reference block error rate value (e.g., BLER_{LOW}), and a zero value (or other reference value). Steps 1612 and 1614 may include comparing the block error rate BLER_{AB} and BLER_{AC} to the first reference block error rate value BLER_{HIGH} and determining whether BLER_{AB} and BLER_{AC} are greater than or equal to BLER_{HIGH}. If the outcome of step 1612 or 1614 is YES (i.e., BLER_{AB} or BLER_{AC} is greater than or equal to BLER_{HIGH}), then the power adjustment value ΔP_{BA} or ΔP_{CA} may be set to a value ΔP₂ for adjusting the transmission power of the second or third node, respectively, in steps 1616 and 1618. The value ΔP₂ may correspond to a positive adjustment (i.e., an increase) to the transmission power of the second or third node in order to reduce the block error rate BLER_{AB} or BLER_{AC}, respectively, to a value below BLER_{HIGH}. In some situations, a high block error rate can be the result of low signal strength, interference, excessive distance, and/or other factors, which can be at least partially overcome (or their effects reduced) by increasing the transmission power of the transmitting node. BLER_{HIGH} may be predetermined based on empirical testing of various operating conditions (e.g., testing various atmospheric conditions, distances between nodes, levels of interference, power level restrictions, etc.) or desired signal parameters, such as a maximum allowable block error rate. In some embodiments, ΔP₂ may be selected from a lookup table, map, or other data structure based on the magnitude of the difference between BLER_{AB} or BLER_{AC} and BLER_{HIGH}. In other embodiments, a single value for ΔP₂ may be used during one or more iterations of method 1600 until BLER_{AB} or BLER_{AC} is less than BLER_{HIGH}. In other embodiments, ΔP₂ may be determined based on one or more measured or determined factors (e.g., the factors discussed above) and an equation, algorithm, or model that incorporates such factors as variables.

If the outcome of step 1612 or 1614 is NO (i.e., BLER_{AB} or BLER_{AC} is less than BLER_{HIGH}), then BLER_{AB} and BLER_{AC} may be compared to both BLER_{HIGH} and a minimum block error rate threshold (e.g., BLER_{LOW}) at steps 1620 and 1622, respectively, to determine whether BLER_{AB} or BLER_{AC} is between BLER_{HIGH} and BLER_{LOW}. BLER_{LOW} may be predetermined based on empirical testing of various operating conditions (e.g., testing various atmospheric conditions, distances between nodes, levels of interference, power level restrictions, etc.) or desired signal parameters, such as a minimum block error rate below which correction thereof or adjustment of the transmission signal power of the transmitting node is less urgent or unnecessary. If the outcome of step 1620 or 1622 is YES (i.e., BLER_{AB} or BLER_{AC} is between BLER_{HIGH} and BLER_{LOW}), then the power adjustment value ΔP_{BA} or ΔP_{CA} may be set to a value ΔP₃ for adjusting the transmission power of the second and third nodes, respectively, in steps 1624 and 1626. The value ΔP₃ may correspond to a positive adjustment (i.e., an increase) to the transmission power of the second or third node in order to reduce the block error rate BLER_{AB} or BLER_{AC}, respectively, to a value below the current block error rate. To avoid high volumes of complex computations for determining a precise value of ΔP₃, the value of ΔP₃ may be may be selected from a lookup table, map, or other data structure based on the magnitude of the difference between BLER_{AB} or BLER_{AC} and BLER_{LOW} and/or BLER_{HIGH}. In other embodiments, a single value for ΔP₃ may be used during one or more iterations of method 1600 until BLER_{AB} or BLER_{AC} is less than BLER_{LOW}. In other embodiments, ΔP₃ may be determined based on one or more measured or determined factors (e.g., the factors discussed above) and an equation, algorithm, or model that incorporates such factors as variables.

If the outcome of step 1620 or 1622 is NO (i.e., BLER_{AB} or BLER_{AC} is less than BLER_{LOW}), then BLER_{AB} and BLER_{AC} may be compared to both BLER_{LOW} and a zero value (e.g., a value corresponding to there being no determined block error rate) at steps 1628 and 1630, respectively, to determine whether BLER_{AB} or BLER_{AC} is between BLER_{LOW} and the zero value. The zero value (represented as “0” in FIG. 16) may be predetermined based on empirical testing of various operating conditions (e.g., testing various atmospheric conditions, distances between nodes, levels of interference, power level restrictions, etc.) or desired signal parameters, such as a block error rate at or below which the block error rate is zero or is reasonably estimated or assumed to be zero such that further lowering is not possible or cannot be reasonably achieved. If the outcome of step 1628 or 1630 is YES (i.e., BLER_{AB} or BLER_{AC} is between BLER_{LOW} and the zero value), then the power adjustment value ΔP_{BA} or ΔP_{CA} may be set to a value ΔP₄ for adjusting the transmission power of the second and third node, respectively, in steps 1632 and 1634. The value ΔP₄ may correspond to a positive adjustment (i.e., an increase) to the transmission power of the second or third node in order to reduce the block error rate BLER_{AB} and BLER_{AC}, respectively, to a value below the current block error rate. To avoid high volumes of complex computations for determining a precise value of ΔP₄, the value of ΔP₄ may be may be selected from a lookup table, map, or other data structure based on the magnitude of the difference between BLER_{AB} or BLER_{AC} and BLER_{LOW} and/or the zero value. In other embodiments, a single value for ΔP₄ may be used during one or more iterations of method 1600 until BLER_{AB} or BLER_{AC} is equal to, approximately equal to, or reasonably determined to be equivalent to the zero value (e.g., based on empirical testing). In other embodiments, ΔP₄ may be determined based on one or more measured or determined factors (e.g., the factors discussed above) and an equation, algorithm, or model that incorporates such factors as variables.

If the outcome of step 1628 or 1630 is NO (i.e., BLER_{AB} or BLER_{AC} is not greater than the zero value), then BLER_{AB} and BLER_{AC} may be compared to the zero value at steps 1636 and 1638, respectively, to determine whether BLER_{AB} or BLER_{AC} is equal to, approximately equal to, or reasonably determined to be equivalent to the zero value. If the outcome of step 1636 or 1638 is YES (i.e., BLER_{CA} is equal to, approximately equal to, or reasonably determined to be equivalent to the zero value), then the power adjustment value ΔP_{BA} and ΔP_{CA} may be set to a value ΔP=0 for adjusting the transmission power of the second and third nodes, respectively, in steps 1640 and 1642 (i.e., to indicate that no adjustment is necessary). If the outcome of either of steps 1636 or 1638 is NO, the exemplary method in FIG. 16 may end.

Although the power adjustment values ΔP₁-ΔP₄ have been described as values to which ΔP_{BA} and ΔP_{CA} may be set for purposes of adjusting the transmission power level of the second and third nodes, it is to be appreciated that more or fewer predetermined adjustment values may be used depending on the number and nature of comparisons used. Additionally, it is to be appreciated that the difference between adjacent values in the range of ΔP₁-ΔP₄ may be the same, different, equally spaced, or unequally spaced. In some embodiments, the values of ΔP₁-ΔP₄ may be related as ΔP₁>ΔP₂>ΔP₃>ΔP₄. In other embodiments, the relative sizes of ΔP₁-ΔP₄ may be arranged differently, depending on determined strategies for adjusting the transmission power level under certain operating conditions, including strategies based on how quickly and/or drastically to adjust the transmission power level of the second and third nodes with each iteration of method 1600.

If the outcome any of step of the exemplary method progresses to step 1644, the power adjustment value ΔP_{BA} or ΔP_{CA} may be transmitted to the second or third node, respectively, at step 1644. For example, the power adjustment value ΔP_{BA} or ΔP_{CA} may be transmitted via transmission module 118 (referring to FIG. 13).

It is to be appreciated that the methods described above with reference to FIG. 16 may be similar to the method described above with reference to FIGS. 6, 11, and 12, and that certain descriptions of the methods described with reference to FIGS. 6, 11, and 12 that pertain to similar features in the methods described with reference to FIG. 16 may equally apply to those methods and vice versa. As with the methods described above with reference to FIGS. 6, 11, and 12, the methods described with reference to FIG. 16 are examples of one methods or processes for implementing aspects of the disclosure and is not intended to be limiting.

Referring again to FIG. 13, communication modules 86 and 88 of Nodes B 72 and C 74 may include demodulation modules 120 and 122, respectively, configured to receive signals including information indicative of the power adjustment values ΔP_{BA} and ΔP_{CA} from Node A 70 via the wireless communication links between them. Demodulation modules 120 and 122 may be configured extract information from the received signals indicative of the power adjustment values ΔP_{BA} and ΔP_{CA}, respectively, (e.g., the power adjustment value determined by the first node based on block error rate and received signal power level information) and demodulate, unpack, decrypt, decode, or otherwise process the received signal from which the power adjustment values ΔP_{BA} and ΔP_{CA} may be obtained. The power adjustment values ΔP_{BA} and ΔP_{CA} may then be communicated from demodulation modules 120 and 122 to power strategy modules 124 and 126, respectively, which may be configured to determine a transmission power level P_{B}⁽ⁿ⁾ and P_{C}⁽ⁿ⁾ for the second and third node, respectively, based on the power adjustment values ΔP_{BA} and ΔP_{CA} that were determined at the first node. In some embodiments, power strategy modules 124 and 126 may be configured to determine the transmission power level ΔP_{BA} and ΔP_{CA}, respectively, for the second and third nodes based on a table of values, map, or other data structure that correlates power adjustment values ΔP_{BA} and ΔP_{CA} with transmission power level values P_{B}⁽ⁿ⁾ and P_{C}⁽ⁿ⁾ for the second and third nodes. In other embodiments, power strategy modules 124 and 126 may be configured to determine the transmission power level P_{B}⁽ⁿ⁾ and P_{C}⁽ⁿ⁾ for the second and third nodes based on an equation, algorithm, or model that incorporates the power adjustment value ΔP_{BA} or ΔP_{CA} as an input variable. The transmission power levels P_{B}⁽ⁿ⁾ and P_{C}⁽ⁿ⁾ for the second and third nodes may be communicated to RFC modules 128 and 130, respectively, which may be configured to control the power level at which signals are transmitted from Node B 72 and Node C 74, respectively. For example, RFC modules 128 and 130 may be configured to control a communication device (e.g., communication device 20 or 28 or the like) to transmit signals at a power level corresponding to the transmission power level P_{B}⁽ⁿ⁾ and P_{C}⁽ⁿ⁾ for the second and third nodes, respectively.

Communication modules 86 and 88 of Nodes B 72 and C 74 may also include RRC modules 132 and 134, respectively, which may be configured to determine whether communication between the second or third node and the first node has faulted. For example, RRC modules 132 and 134 may be configured to analyze time stamps associated with data packets received from Node A 70 to determine whether communication between Node B 72 or Node C 74 and Node A 70 has faulted. Alternatively, RRC modules 132 and 134 may be configured to compare a local time associated with Nodes B 72 and C 74 to a local time associated with Node A, a time scale associated with another node, or a global time scale, and determine whether the communication between Node B 72 or C 74 and Node A 70 has faulted. Other methods of determining whether communication between nodes are is not faulted may be used. When RRC modules 132 and 134 determine that communication between Node B 72 or Node C 74 and Node A 70 has faulted, RRC modules 132 and 134 may send a signal to a respective reset module 136 or 138, indicating that communication between the nodes has faulted. When reset module 136 or 138 receives a signal from RRC module 132 or 134, respectively, indicating that communication between the nodes has faulted, the reset modules 136 and 138 may be configured to generate a signal indicative of a default power transmission level P_{B}^{DEF} or P_{C}^{DEF} for the second or third node, respectively. When communication between the nodes has faulted, the power adjustment value ΔP_{BA} or ΔP_{CA} received from the first node may be inaccurate, indeterminate, or may not have been received due to the fault. To ensure the quality of signals generated by the second and third nodes and/or to remedy the fault in communication among the nodes, RFC modules 128 and 130 may control the transmission power level of the second and third nodes, respectively, based on the default power transmission levels P_{B}^{DEF} and P_{C}^{DEF} received from reset modules 136 and 138 until no fault exists.

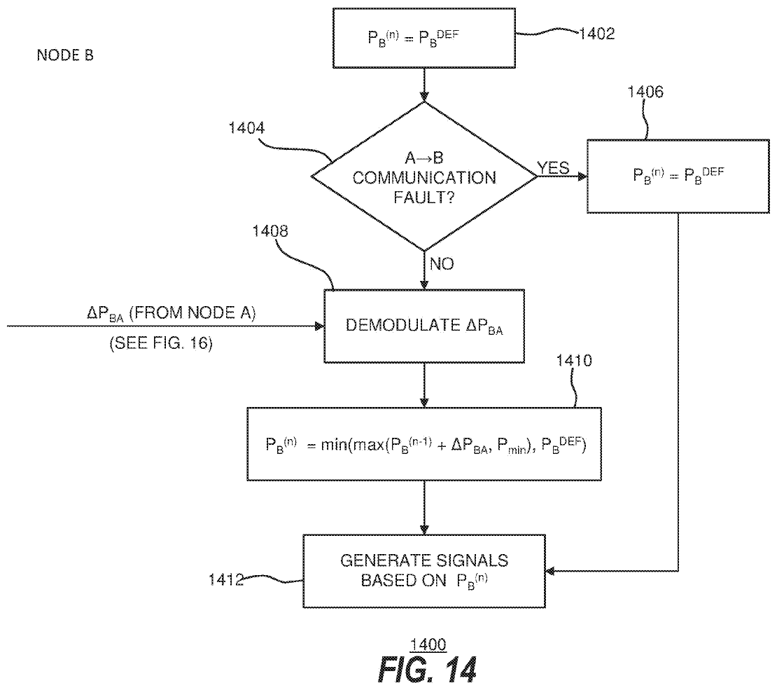

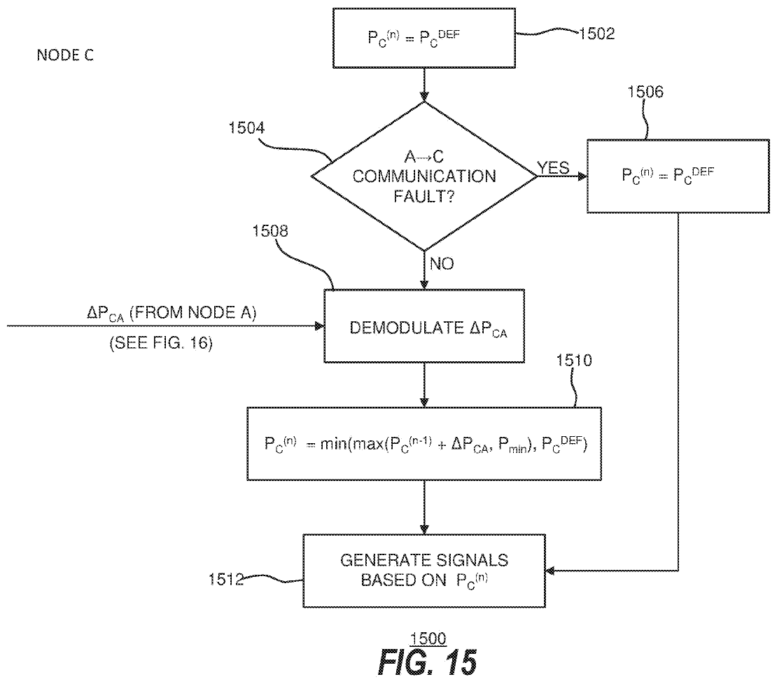

FIGS. 14 and 15 show exemplary methods 1400 and 1500 for controlling a transmission power of a wireless communication device that may be used in accordance with the illustrative embodiments discussed above. Methods 1400 and 1500 include steps 1402-1412 and 1502-1012, respectively, which substantially correspond to steps 502-512 of method 500 shown in FIG. 5 and described above, the difference being that method 1400 corresponds to control of Node B and method 1500 corresponds to control of Node C, each respectively based on power adjustment values ΔP_{BA} and ΔP_{CA}. Accordingly, exemplary methods 1400 and 1500 will not be described in further detail, and it is to be appreciated that descriptions applicable to method 500 apply equally to methods 1400 and 1500 in terms of how each corresponding step is carried out. Methods 1400 and 1500 may be carried out by control modules 86 and 88, respectively, in conjunction with a communication device (e.g., communication device 20 or 28 or the like).

In some embodiments, one or more nodes in a communication network (e.g., Node A 70, Node B 72, Node C 74, etc.) may function as a receiving node and as a transmitting node. That is, each such node may be configured to transmit signals (and receive power adjustment values from one or more other nodes) and receive signals (and transmit power adjustment values to other nodes), as described in the exemplary embodiments disclosed herein. For example, in some situations, a node may engage in communication with at least a first other node by transmitting signals to the first other node, while simultaneously engaging in communication with at least a second other node by receiving signals from the second other node. In other situations, a node may transmit signals to multiple other nodes while simultaneously receiving signals from multiple other nodes.

When a first node engages in communication as both a transmitting node and a receiving node (e.g., simultaneously), the first node may simultaneously engage in multiple power control processes disclosed hereinabove. That is, the first node may engage in iterative control of the transmission power of one or more other nodes while simultaneously engaging in iterative control of its own transmission power based on adjustment values received from one or more other nodes. Engaging in such processes may involve adjusting transmission power to overcome background nose and/or reducing gaps between the signal to noise ratio or received signal power among other nodes and itself.

For example, in some embodiments, a first node may be configured to communicate wirelessly with other nodes, the first node comprising a memory having instructions stored therein, and an electronic control unit comprising a processor. The processor may be configured to execute the stored instructions to execute method or process steps consistent with embodiments described herein above when acting as a transmitting node. For example, the first node may be configured to establish a wireless communication link between the first node and a second node. The first node may also be configured to receive a first power adjustment value from the second node, wherein the first power adjustment value is determined based on signals transmitted by the first node over the first wireless communication link. The first node may also be configured to determine a transmission power level for transmitting signals to the second node based on the received first power adjustment value. The first node may be configured to then transmit signals to the second node using the determined transmission power level. In this way the first node may be configured to function as a transmitting node consistent with embodiments described herein. Additionally, the first node may also be configured to also or simultaneously function as a receiving node consistent with embodiments described herein above. For example, the first node may also be configured to determine a first block error rate and a first received signal power level at the first node based on signals transmitted by the second node over the first wireless communication link. The first node may also be configured to obtain a first power adjustment value for the second node based on the first block error rate and the first received power level. The first node may also be configured to then transmit the first power adjustment value from the first node to the second node, wherein the second node is configured to use the power adjustment value to control its transmission power over the first wireless communication link.

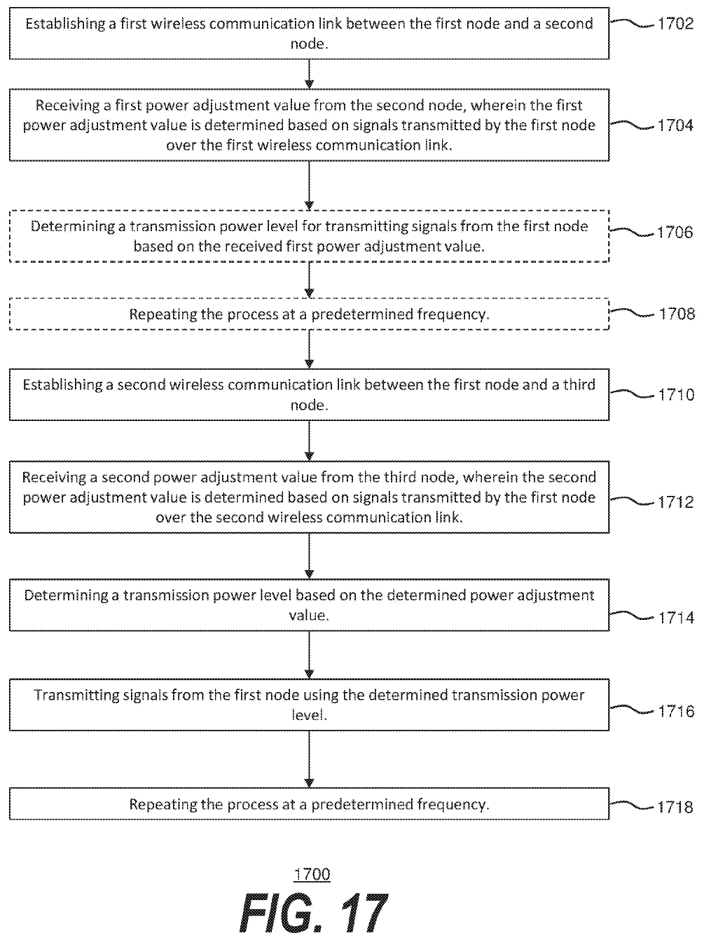

FIG. 17 shows an exemplary method 1700 of controlling a transmission power of a wireless communication device that may be used in accordance with illustrative embodiments of the present disclosure described above. Step 1702 includes Establishing a first wireless communication link between the first node and a second node. For example, establishing a wireless communication link between the first node and a second node may include establishing a communication link between a movable object (e.g., a UAV) and another movable object (e.g., another movable object, a handheld object, etc.) or a stationary object. Step 1704 may include receiving a first power adjustment value from the second node, wherein the first power adjustment value is determined based on signals transmitted by the first node over the first wireless communication link. Step 1706 may include determining a transmission power level for transmitting signals from the first node based on the received first power adjustment value. Step 1708 may include Repeating the process at a predetermined frequency. Steps 1706 and 1708 are shown in FIG. 17 as being surrounded by dashed lines to indicate that these steps are optional in the embodiment shown, but would be conducted during situations of one-to-one communication. Step 1710 may include Establishing a second wireless communication link between the first node and a third node. Step 1712 may include Receiving a second power adjustment value from the third node, wherein the second power adjustment value is determined based on signals transmitted by the first node over the second wireless communication link. Step 1714 may include Determining a transmission power level based on the determined power adjustment value. Step 1716 may include Transmitting signals from the first node using the determined transmission power level. And step 1718 may include Repeating the process at a predetermined frequency. Some steps in method 1700 may be performed in a different order, and that method 1700 may include more or fewer steps (such as any method step described herein above). Method 1700, as with any sequence of steps described in this disclosure herein above or below, may be repeated, such as to perform an iterative process of adjusting the transmission power of one or more nodes.

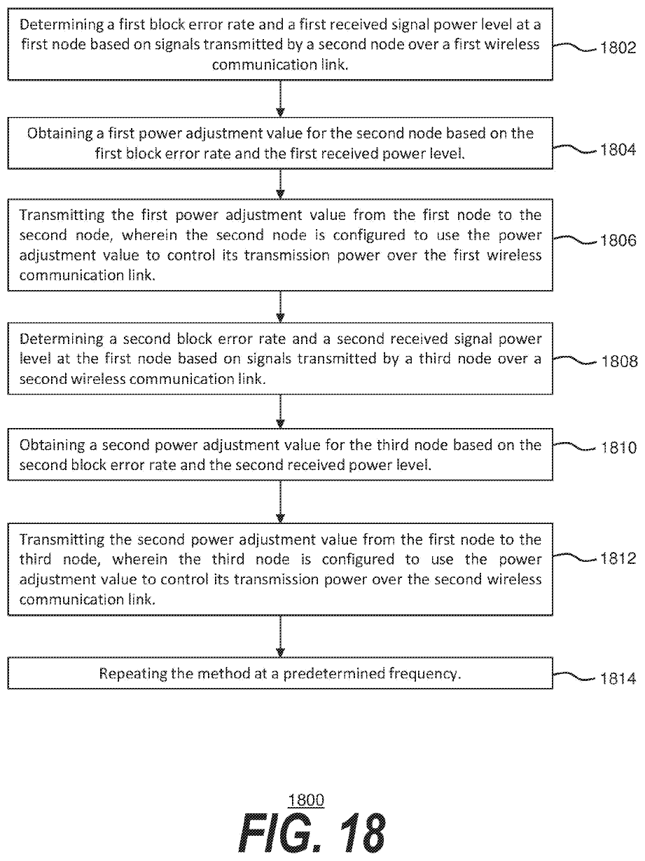

FIG. 18 shows exemplary method of controlling a transmission power of a wireless communication device that may be used in accordance with illustrative embodiments of the present disclosure discussed above. Step 1802 may include determining a first block error rate and a first received signal power level at a first node based on signals transmitted by a second node over a first wireless communication link. Step 1804 may include obtaining a first power adjustment value for the second node based on the first block error rate and the first received power level. Step 1806 may include transmitting the first power adjustment value from the first node to the second node, wherein the second node is configured to use the power adjustment value to control its transmission power over the first wireless communication link. Step 1808 may include determining a second block error rate and a second received signal power level at the first node based on signals transmitted by a third node over a second wireless communication link. Step 1810 may include obtaining a second power adjustment value for the third node based on the second block error rate and the second received power level. Step 1812 may include transmitting the second power adjustment value from the first node to the third node, wherein the third node is configured to use the power adjustment value to control its transmission power over the second wireless communication link. Step 1814 may include Repeating the method at a predetermined frequency. It is to be appreciated that method 1800 may include more or fewer steps (such as any method step described herein above). Further, some steps in method 1800 may be performed in a different order. Method 1800, as with any sequence of steps described in this disclosure herein above or below, may be repeated, such as to perform an iterative process of adjusting the transmission power of one or more nodes.

Those skilled in the art will also recognize the exemplary comparisons in each of the disclosed embodiments may be performed in equivalent ways, such as for example replacing “greater than or equal to” comparisons with “greater than,” or vice versa, depending on the predetermined threshold values being used. Further, it will also be understood that the exemplary threshold values in the disclosed embodiments may be modified, for example, replacing any of the exemplary zero values with other reference values, or combined with one or more other values.

It will be further apparent to those skilled in the art that various other modifications and variations can be made to the disclosed methods and systems. Other embodiments will be apparent to those skilled in the art from consideration of the specification and practice of the disclosed methods and systems. For example, while the disclosed embodiments are described with reference to an exemplary movable object 10 and second object 26, those skilled in the art will appreciate the invention may be applicable in other wireless communication systems with different types of transmitting and receiving nodes. It is intended that the specification and examples be considered as exemplary only, with a true scope being indicated by the following claims and their equivalents

What is claimed is:

1. A method of controlling a transmission power over a wireless communication network, the method comprising:
determining a first block error rate and a first received signal power level at a first node based on signals transmitted by a second node over a first wireless communication link;
obtaining a first power adjustment value for the second node based on the first block error rate and the first received power level; and
transmitting the first power adjustment value from the first node to the second node, wherein the second node is configured to use the power adjustment value to control its transmission power over the first wireless communication link.

2. The method of claim 1, wherein the first power adjustment value correspond to a decrease of the transmission power of the second node when the first received signal power exceeds a threshold.

3. The method of claim 1, wherein the first power adjustment value is selected from a plurality of predetermined power adjustment values based on the first block error rate.

4. The method of claim 1, further including:
determining a second block error rate and a second received signal power level at the first node based on signals transmitted by a third node over a second wireless communication link;
obtaining a second power adjustment value for the third node based on the second block error rate and the second received power level; and
transmitting the second power adjustment value from the first node to the third node, wherein the third node is configured to use the power adjustment value to control its transmission power over the second wireless communication link.

5. The method of claim 4, wherein the first and second power adjustment values are different values.

6. The method of claim 4, wherein the first and second power adjustment values are determined independently of each other.

7. The method of claim 4, wherein the second power adjustment value is determined based on the magnitude of the second block error rate.

8. The method of claim 4, wherein the second power adjustment value corresponds to an increase or a decrease of the transmission power of the third node.

9. The method of claim 4, wherein the second power adjustment value correspond to a decrease of the transmission power of the third node when the second received signal power exceeds a threshold.

10. The method of claim 4, wherein the second power adjustment value is selected from a plurality of predetermined power adjustment values based on the second block error rate.

11. The method of claim 10, wherein the plurality of predetermined adjustment values includes values of varying magnitude.

12. The method of claim 10, wherein the second power adjustment value increases in magnitude as the second block error rate increases.

13. The method of claim 4, wherein the first and second power adjustment values are obtained to reduce a difference between the first and second received signal powers.

14. The method of claim 4, wherein the obtained first and second power adjustment values correspond to a decrease in the transmission power of at least one of the second or third nodes, respectively.

15. The method of claim 4, wherein the obtained first and second power adjustment values correspond to an increase in the transmission power of one of the second and third nodes and a decrease in the transmission power of the other of the second and third nodes.

16. The method of claim 4, wherein the first and second power adjustment values are obtained based on a background noise level.

17. The method of claim 4 wherein the first and second power adjustment values are obtained based on a background noise level and to reduce a difference between the first and second received signal powers.

18. A communication system that includes a plurality of nodes, the system, comprising:
a first node configured to communicate wirelessly with other nodes, the first node comprising:
a memory having instructions stored therein; and
an electronic control unit comprising a processor configured to execute the stored instructions to:
determine a first block error rate and a first received signal power level at a first node based on signals transmitted by a second node over a first wireless communication link;
obtain a first power adjustment value for the second node based on the first block error rate and the first received power level; and
transmit the first power adjustment value from the first node to the second node, wherein the second node is configured to use the power adjustment value to control its transmission power over the first wireless communication link.

19. The communication system of claim 18, further including:
determining a second block error rate and a second received signal power level at the first node based on signals transmitted by a third node over the wireless communication link;
obtaining a second power adjustment value for the third node based on the second block error rate and the second received power level; and
transmitting the second power adjustment value from the first node to the third node, wherein the third node is configured to use the power adjustment value to control its transmission power over a second wireless communication link.

20. A communication system that includes a plurality of nodes, the system comprising:
a first node configured to communicate wirelessly with other nodes, the first node comprising:
a memory having instructions stored therein; and
an electronic control unit comprising a processor configured to execute the stored instructions to:
establish a wireless communication link between the first node and a second node;
receive a first power adjustment value from the second node,
wherein the first power adjustment value is determined based on signals transmitted by the first node over the first wireless communication link;
determine a transmission power level for transmitting signals to the second node based on the received first power adjustment value;
transmit signals to the second node using the determined transmission power level;
determine a first block error rate and a first received signal power level at the first node based on signals transmitted by the second node over the first wireless communication link;
obtain a first power adjustment value for the second node based on the first block error rate and the first received power level; and
transmit the first power adjustment value from the first node to the second node, wherein the second node is configured to use the power adjustment value to control its transmission power over the first wireless communication link.
